(19) United States
(12) Patent Application Publication
(10) Pub. No.: US 2026/0318428 A1
(43) Pub. Date: Oct. 15, 2026

(54) COMPOSITE VALVE DEVICE AND TEMPERATURE CONTROL DEVICE USING SAME

(71) Applicant: SHINWA CONTROLS CO., LTD., Kawasaki-shi, Kanagawa (JP)

(72) Inventors: Ryoji ICHIYAMA, Kawasaki-shi (JP); Tetsuya OKAJIMA, Kawasaki-shi (JP)

(73) Assignee: SHINWA CONTROLS CO., LTD., Kawasaki-shi, Kanagawa (JP)

(21) Appl. No.: 19/484,475

(22) PCT Filed: Mar. 29, 2024
(86) PCT No.: PCT/JP2024/012974

§ 371 Date: Nov. 14, 2025

(30) Foreign Application Priority Data
Oct. 23, 2023 (JP) 2023-181987

(51) Int. Cl. F16K 11/074; F16K 25/00

(52) U.S. Cl. CPC F16K 11/074; F16K 25/005

(57) ABSTRACT

Provided is a composite valve device that enables one valve device to fulfill functions corresponding to a plurality of valve devices that distribute a fluid and mix fluids. The composite valve device includes: a fixed-side valve body having: a plurality of flow ports being independent of each other; and branching/mixing flow ports, which are formed such that at least two branching/mixing flow ports correspond to each of the flow ports, the branching/mixing flow ports each allowing a fluid flowing through each of the flow ports to be branched or mixed and flow; and a movable valve body movably arranged in close contact with the fixed-side valve body, the movable valve body having a plurality of variable communication paths, each allowing communication of each of the flow ports and the at least two branching/mixing flow ports corresponding to the flow port while the fluid is branched or mixed at a variable branching/mixture ratio. The composite valve device is configured to function simultaneously as a plurality of valve devices.

### TECHNICAL FIELD

The present invention relates to a composite valve device and a temperature control device using the same.

### BACKGROUND ART

Hitherto, as a technology relating to a valve device such as a three-way valve and a temperature control device using the valve device, the applicant of the present invention has already proposed those disclosed in Patent Literature 1 and Patent Literature 2.

A temperature control device disclosed in Patent Literature 1 includes: a valve main body including a valve seat, the valve seat having a columnar space and having a first valve port, which allows inflow of a first fluid and has a rectangular cross section, and a second valve port, which allows inflow of a second fluid and has a rectangular cross section; a valve body being provided in a freely rotatable manner in the valve seat of the valve main body so as to simultaneously switch the first valve port from a closed state to an opened state and switch the second valve port from an opened state to a closed state, the valve body having a half-cylindrical shape with a predetermined central angle and having a curved-surface shape at each of both end surfaces of the valve body in a circumferential direction; and drive means for driving the valve body to rotate.

A temperature control device disclosed in Patent Literature 2 includes: first supply means for supplying a lower temperature fluid f adjusted to a first predetermined lower temperature; second supply means for supplying a higher temperature fluid adjusted to a second predetermined higher temperature; a first three-way valve for flow rate control configured to mix the lower temperature fluid supplied from the first supply means and the higher temperature fluid supplied from the second supply means while controlling only a flow rate of the lower temperature fluid and a flow rate of the higher temperature fluid to form a fluid for temperature control and then supply the fluid for temperature control to a temperature control target; a second three-way valve for flow rate control configured to distribute the fluid for temperature control having flowed through the temperature control target, only to the first supply means and the second supply means while controlling a flow rate of the fluid for temperature control; a third three-way valve for flow rate control configured to control both of the flow rate of the fluid for temperature control, which flows through the temperature control target and is distributed by the second three-way valve for flow rate control to the first supply means, and the flow rate of the lower temperature fluid, which is prevented from being supplied from the first supply means to the first three-way valve for flow rate control and is returned to the first supply means; and a fourth three-way valve for flow rate control configured to control both of the flow rate of the fluid for temperature control, which flows through the temperature control target and is distributed by the second three-way valve for flow rate control to the second supply means, and the flow rate of the higher temperature fluid, which is prevented from being supplied from the second supply means to the first three-way valve for flow rate control and is returned to the second supply means.

### CITATION LIST

### Patent Literature

[PTL 1] JP 6104443 B1

[PTL 2] JP 6990058 B2

### SUMMARY OF INVENTION

### Technical Problem

An object of the present invention is to provide a composite valve device that enables one valve device to fulfill functions corresponding to a plurality of valve devices that distribute a fluid and mix fluids.

### Solution to Problem

According to the invention described in claim 1, there is provided a composite valve device, including: a fixed-side valve body having: a plurality of flow ports being independent of each other; and branching/mixing flow ports, which are formed such that at least two branching/mixing flow ports correspond to each of the flow ports, the branching/mixing flow ports each allowing a fluid flowing through each of the flow ports to be branched or mixed and flow; and a movable valve body movably arranged in close contact with the fixed-side valve body, the movable valve body having a plurality of variable communication paths, each allowing communication of each of the flow ports and the at least two branching/mixing flow ports corresponding to the flow port while the fluid is branched or mixed at a variable branching/mixture ratio. The composite valve device is configured to function simultaneously as a plurality of valve devices.

According to the invention described in claim 2, in the composite valve device described in claim 1, the fixed-side valve body is formed of a fixed disc having a circular shape in plan view, the plurality of flow ports are arranged on an inner periphery side in a circumferential direction on the fixed disc, and the at least two branching/mixing flow ports formed corresponding to each of the flow ports are arranged on an outer periphery side of the corresponding one of the flow ports of the fixed disc in a radial direction.

According to the invention described in claim 3, in the composite valve device described in claim 2, when the number of flow ports is represented by N, the plurality of flow ports are arranged at positions obtained by equally dividing the fixed disc by N in the circumferential direction of the fixed disc.

According to the invention described in claim 4, in the composite valve device described in claim 2, the branching/mixing flow ports, which are formed such that at least two branching/mixing flow ports correspond to each of the flow ports, are arranged adjacent to each other in the circumferential direction of the fixed disc.

According to the invention described in claim 5, in the composite valve device described in claim 2, the branching/mixing flow ports, which are formed such that at least two branching/mixing flow ports correspond to each of the flow ports, are arranged spaced apart from each other in the circumferential direction of the fixed disc.

According to the invention described in claim 6, in the composite valve device described in claim 1, the movable valve body is formed of a movable disc having a circular shape in plan view, which is rotatably arranged in close contact with the fixed-side valve body, and the plurality of variable communication paths are arranged spaced apart from each other in a circumferential direction of the movable disc.

According to the invention described in claim 7, in the composite valve device described in claim 6, each of the variable communication paths is formed in a groove shape in a radial direction of the movable disc, the groove shape being opened only on the fixed-side valve body side.

According to the invention described in claim 8, in the composite valve device described in claim 1, each of the variable communication paths has an end portion on a side corresponding to the flow ports and an end portion on a side corresponding to the branching/mixing flow ports of the fixed-side valve body, the end portions being formed in shapes corresponding to an opening shape of each of the flow ports and an opening shape of each of the branching/mixing flow ports, respectively.

According to the invention described in claim 9, in the composite valve device described in claim 8, the opening shape of each of the flow ports and the opening shape of each of the branching/mixing flow ports are each a fan-like shape or a circular shape.

According to the invention described in claim 10, in the composite valve device described in claim 9, one of the end portions of each of the plurality of variable communication paths is constantly in communication with a corresponding one of the flow ports even when the movable valve body is moved.

According to the invention described in claim 11, in the composite valve device described in claim 1, each of the variable communication paths is, at a first position, in communication with the each flow port and one of the at least two branching/mixing flow ports of the fixed-side valve body, at a second position, in communication with the each flow port and both of the at least two branching/mixing flow ports of the fixed-side valve body, and at a third position, in communication with the each flow port and another one of the at least two branching/mixing flow ports.

According to the invention described in claim 12, in the composite valve device described in claim 11, at the first position, one of the at least two branching/mixing flow ports formed corresponding to each of the plurality of flow ports, with which one of two of the plurality of variable communication paths is in communication, is different from one of the at least two branching/mixing flow ports, with which another one of the two variable communication paths is in communication.

According to the invention described in claim 13, in the composite valve device described in claim 1, the plurality of flow ports include three flow ports through which a higher temperature fluid being the same fluid at a relatively high temperature, a lower temperature fluid being the same fluid at a relatively low temperature, and a mixed fluid in which the higher temperature fluid and the lower temperature fluid are mixed are allowed to flow, respectively.

According to the invention described in claim 14, in the composite valve device described in claim 1 or 13, among the plurality of flow ports and the branching/mixing flow ports of the fixed valve body, which are formed such that at least two branching/mixing flow ports correspond to each of the flow ports, a specific one of the flow ports and specific ones of the branching/mixing flow ports are connected in advance on the fixed valve body side.

According to the invention described in claim 15, in the composite valve device described in claim 14, one of the specific branching/mixing flow ports is a main branching/mixing flow port, through which the higher temperature fluid is allowed to mainly flow, and one of the specific branching/mixing flow ports is a main branching/mixing flow port, through which the lower temperature fluid is allowed to mainly flow.

According to the invention described in claim 16, in the composite valve device described in claim 14, one of the specific branching/mixing flow ports is a sub branching/mixing flow port, through which the higher temperature fluid is allowed to be branched and flow, and one of the specific branching/mixing flow ports is a sub branching/mixing flow port, through which the mixed fluid is allowed to be branched into the higher temperature fluid and flow.

According to the invention described in claim 17, in the composite valve device described in claim 14, one of the specific branching/mixing flow ports is a sub branching/mixing flow port, through which the lower temperature fluid is allowed to be branched and flow, and one of the specific branching/mixing flow ports is a sub branching/mixing flow port, through which the mixed fluid is allowed to be branched into the lower temperature fluid and flow.

According to the invention described in claim 18, in the composite valve device described in claim 13, the plurality of flow ports and the branching/mixing flow ports, which are formed such that at least two branching/mixing flow ports correspond to each of the flow ports, include: a main higher-temperature-side branching/mixing flow port and a sub higher-temperature-side branching/mixing flow port, through which the higher temperature fluid is allowed to be branched and flow; a main lower-temperature-side branching outflow port and a sub lower-temperature-side branching outflow port, through which the lower temperature fluid is allowed to be branched and flow; and a higher-temperature-side branching/mixing flow port and a lower-temperature-side branching/mixing flow port, through which the mixed fluid is allowed to be branched and flow, and a supply-side branching/mixing flow port, which allows the mixed fluid to be branched to a supply side of the mixed fluid.

According to the invention described in claim 19, in the composite valve device described in claim 18, the higher-temperature-side main branching/mixing flow port, the lower-temperature-side main branching/mixing flow port, and the supply-side branching/mixing flow port are connected in advance to each other on the fixed valve body side.

According to the invention described in claim 20, in the composite valve device described in claim 18, the higher-temperature-side sub branching/mixing flow port, the higher-temperature-side branching/mixing flow port are connected in advance to each other on the fixed valve body side.

According to the invention described in claim 21, in the composite valve device described in claim 18, the higher-temperature-side sub branching/mixing flow port, the lower-temperature-side sub branching/mixing flow port, and the supply-side branching/mixing flow port are connected in advance to each other on the fixed valve body side.

According to the invention described in claim 22, in the composite valve device described in claim 1, each of the fixed-side valve body and the movable main body is made of a ceramic.

According to the invention described in claim 23, in the composite valve device described in claim 22, the plurality of flow ports and the plurality of branching/mixing flow ports formed in the fixed-side valve body, and the plurality of variable communication paths formed in the movable valve body each have corner portions each formed in a curved shape in plan view.

According to the invention described in claim 24, there is provided a temperature control device, including: temperature control target having a flow passage for temperature control, through which a fluid for temperature control including a lower temperature fluid and a higher temperature fluid, which are mixed at an adjusted mixture ratio, is allowed to flow; first supply portion for supplying the lower temperature fluid adjusted to predetermined lower-temperature-side first temperature ; second supply portion for supplying the higher temperature fluid adjusted to a predetermined higher-temperature-side second temperature; and a composite valve device connected to the first supply portion and the second supply portion, the composite valve device being configured to allow the lower temperature fluid supplied from the first supply portion and the higher temperature fluid supplied from the second Supply portion to flow through the flow passage for temperature control after adjusting the mixture ratio and to branch and return a mixed fluid of the lower temperature fluid and the higher temperature fluid, which has flowed through the flow passage for temperature control, to the first supply portion and the second supply portion. The composite valve device described in any one of claims 1 to 23 is used as the composite valve device.

### Advantageous Effects of Invention

According to the present invention, it is possible to provide the composite valve device that enables one valve device to fulfill functions corresponding to a plurality of valve devices that distribute a fluid and mix fluids.

### BRIEF DESCRIPTION OF DRAWINGS

FIG. 1 is a perspective view for illustrating an outer appearance of a composite valve device according to a first embodiment of the present invention.

FIG. 2(a) is a front view for illustrating the composite valve device according to the first embodiment of the present invention.

FIG. 2(b) is a right side view for illustrating the composite valve device according to the first embodiment of the present invention.

FIG. 2(c) is a plan view for illustrating the composite valve device according to the first embodiment of the present invention.

FIG. 3 is an exploded perspective view for illustrating the composite valve device according to the first embodiment of the present invention.

FIG. 4(a) is a rear view for illustrating relevant parts of the composite valve device according to the first embodiment of the present invention.

FIG. 4(b) is a sectional view taken along the line A-A as viewed in the direction of arrows for illustrating relevant parts of the composite valve device according to the first embodiment of the present invention.

FIG. 5(a) is a plan view for illustrating a valve main body.

FIG. 5(b) is a left side view for illustrating the valve main body.

FIG. 5(c) is a front view for illustrating the valve main body.

FIG. 5(d) is a right side view for illustrating the valve main body.

FIG. 5(e) is a rear view for illustrating the valve main body.

FIG. 5(f) is a sectional view taken along the line B-B of FIG. 5(a) as viewed in the direction of arrows.

FIG. 6 is a perspective configuration view for illustrating the valve main body and relevant parts.

FIG. 7 is a sectional view taken along the line VII-VII of FIG. 6 as viewed in the direction of arrows.

FIG. 8(a) is a perspective configuration view for illustrating a fixed disc.

FIG. 8(b) is a plan view for illustrating the fixed disc. FIG. 8(c) is a back view for illustrating the fixed disc.

FIG. 9(a) is a perspective configuration view for illustrating a movable disc.

FIG. 9(b) is a plan view (or a top view) for illustrating the movable disc.

FIG. 9(c) is a back view for illustrating the movable disc.

FIG. 10(a) is a plan view for illustrating a modification example of the fixed disc and the movable disc.

FIG. 10(b) is a plan configuration view for illustrating another modification example of the fixed disc and the movable disc.

FIG. 11(a) is a sectional view for illustrating relevant parts of the composite valve device according to the first embodiment of the present invention.

FIG. 11(b) is an enlarged view of relevant parts of FIG. 11(a).

FIG. 12(a) is a plan configuration view for illustrating an operation of the composite valve device according to the first embodiment of the present invention.

FIG. 12(b) is a plan configuration view for illustrating a further operation of the composite valve device according to the first embodiment of the present invention.

FIG. 13(a) is a schematic diagram for illustrating a temperature control device to which the composite valve device according to the first embodiment of the present invention is applied.

FIG. 13(b) is an equivalent circuit diagram for illustrating flow passages obtained when the composite valve device 1 according to the first embodiment is replaced by three three-way valves that fulfill the same functions.

FIG. 14(a) is a schematic view for illustrating an operation of the temperature control device to which the composite valve device according to the first embodiment of the present invention is applied.

FIG. 14(b) is a schematic view for illustrating the operation of the temperature control device to which the composite valve device according to the first embodiment of the present invention is applied.

FIG. 14(c) is a schematic view for illustrating the operation of the temperature control device to which the composite valve device according to the first embodiment of the present invention is applied.

FIG. 14(d) is a schematic view for illustrating the operation of the temperature control device to which the composite valve device according to the first embodiment of the present invention is applied.

FIG. 14(e) is a schematic view for illustrating the operation of the temperature control device to which the composite valve device according to the first embodiment of the present invention is applied.

FIG. 15(a) is a configuration view for illustrating relevant parts of a composite valve device according to a second embodiment of the present invention.

FIG. 15(b) is a sectional view taken along the line A-A of FIG. 15(a) as viewed in the direction of arrows.

FIG. 16(a) is a plan view for illustrating a fixed disc.

FIG. 16(b) is a back view for illustrating the fixed disc.

FIG. 16(c) is a sectional view for illustrating the fixed disc.

FIG. 17(a) is a back view for illustrating a movable disc.

FIG. 17(b) is a plan view (or a top view) for illustrating the movable disc.

FIG. 17(c) is a sectional view for illustrating the movable disc.

FIG. 18(a) is a sectional view for illustrating relevant parts of the movable disc.

FIG. 18(b) is a schematic view for illustrating the relevant parts of the movable disc.

FIG. 19 is a schematic diagram for illustrating a temperature control device to which the composite value device according to the second embodiment of the present invention is applied.

FIG. 20 is a configuration view for illustrating an operation of the composite valve device according to the second embodiment of the present invention.

FIG. 21 is a configuration view for illustrating the operation of the composite valve device according to the second embodiment of the present invention.

FIG. 22 is a configuration view for illustrating the operation of the composite valve device according to the second embodiment of the present invention.

FIG. 23 is a configuration view for illustrating the operation of the composite valve device according to the second embodiment of the present invention.

FIG. 24 is a configuration view for illustrating the operation of the composite valve device according to the second embodiment of the present invention.

FIG. 25 is a perspective configuration view for illustrating relevant parts of a composite valve device according to a third embodiment of the present invention.

FIG. 26(a) is a configuration view for illustrating a fixed disc of a composite valve device according to a fourth embodiment of the present invention.

FIG. 26(b) is a configuration view for illustrating a movable disc of the composite valve device according to the fourth embodiment of the present invention.

FIG. 27(a) is a configuration view for illustrating an operation of the composite valve device according to the fourth embodiment of the present invention.

FIG. 27(b) is a configuration view for illustrating the operation of the composite valve device according to the fourth embodiment of the present invention.

FIG. 27(c) is a configuration view for illustrating the operation of the composite valve device according to the fourth embodiment of the present invention.

FIG. 27(d) is a configuration view for illustrating the operation of the composite valve device according to the fourth embodiment of the present invention.

FIG. 27(e) is a configuration view for illustrating the operation of the composite valve device according to the fourth embodiment of the present invention.

FIG. 28 is a graph for showing measurement values of flow coefficient Cv values of fluids in the composite valve device according to the second embodiment of the present invention.

FIG. 29(a) is a circuit diagram for illustrating a temperature control device according to a fifth embodiment of the present invention.

FIG. 29(b) is an equivalent circuit diagram for illustrating the temperature control device according to the fifth embodiment of the present invention.

FIG. 30(a) is an equivalent circuit diagram for illustrating the temperature control device according to the fifth embodiment of the present invention.

FIG. 30(b) is an equivalent circuit diagram for illustrating the temperature control device according to the fifth embodiment of the present invention.

### DESCRIPTION OF EMBODIMENTS

Now, modes for carrying out the present invention (hereinafter referred to as “embodiments”) are described with reference to the drawings.

### First Embodiment

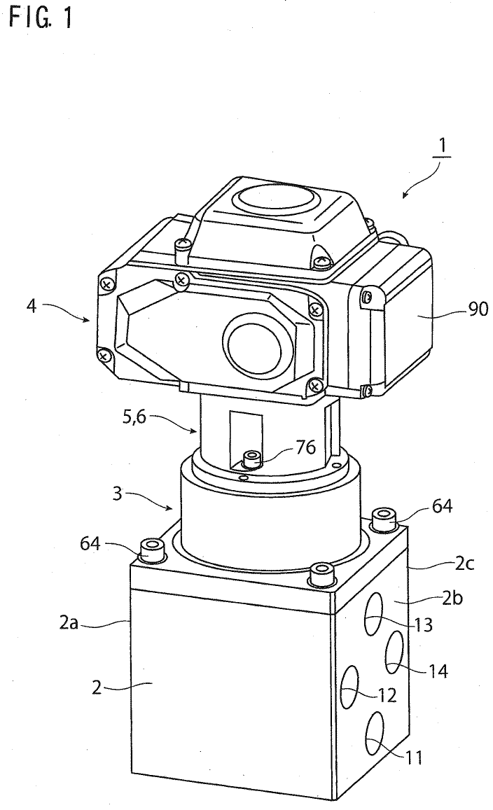

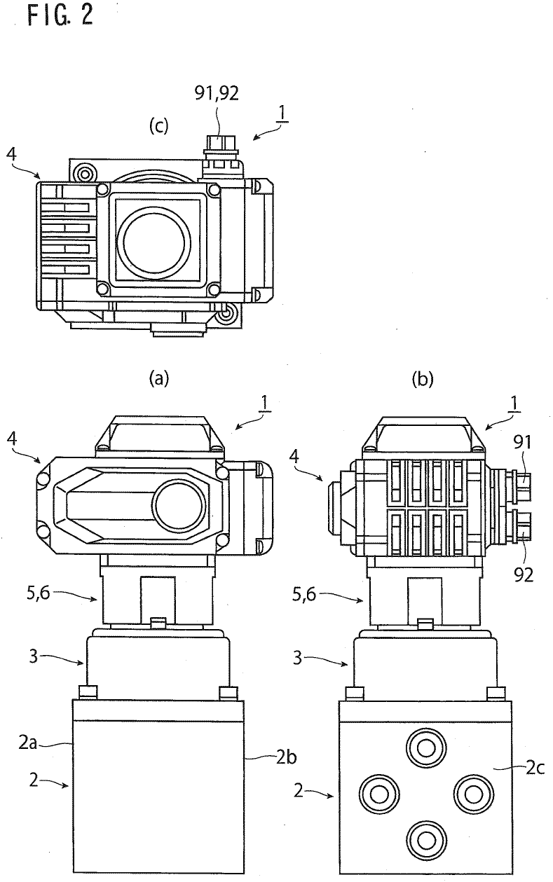

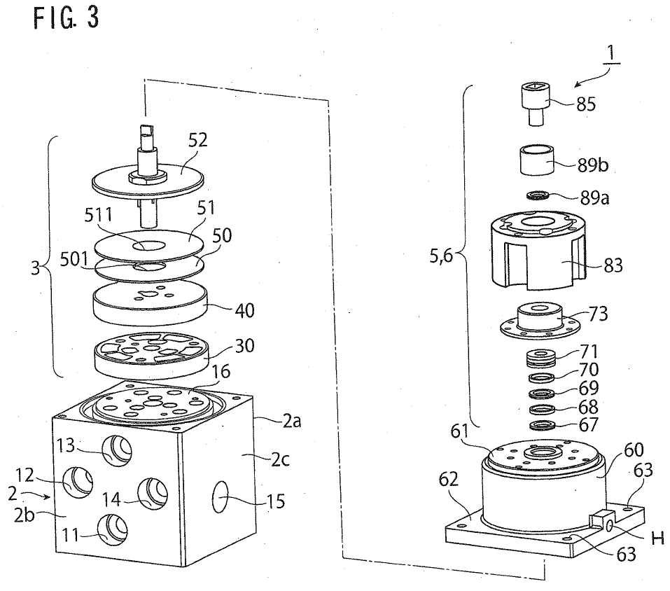

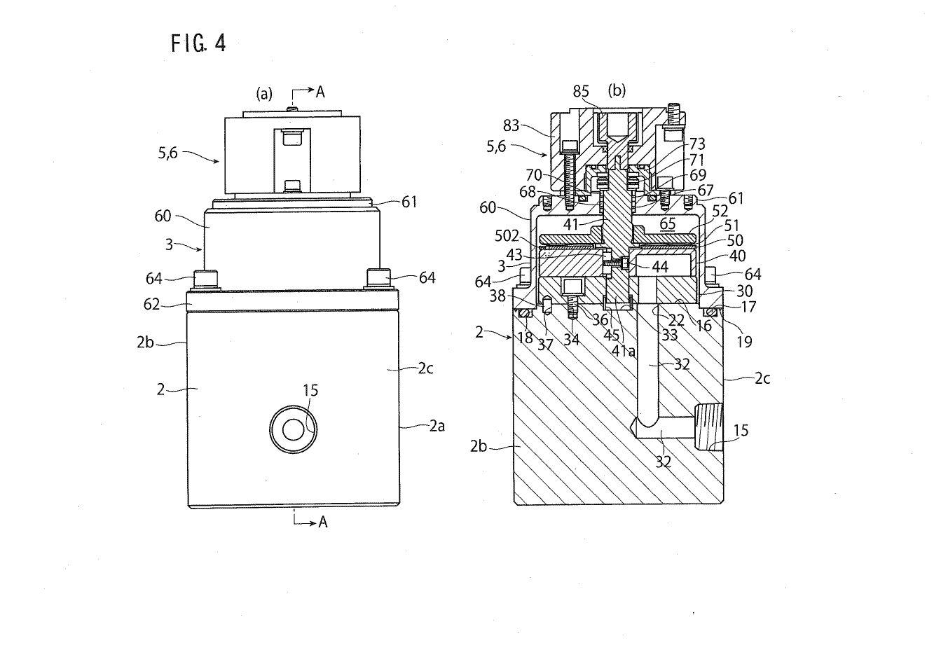

FIG. 1 is a perspective view for illustrating an outer appearance of a composite valve device according to a first embodiment of the present invention; FIG. 2(a), FIG. 2(b), and FIG. 2(c) are a front view, a right side view, and a plan view for illustrating the composite valve device; FIG. 3 is an exploded perspective view for illustrating the composite valve device; and FIG. 4(a) and FIG. 4(b) are a rear view for illustrating relevant parts of the composite valve device and a sectional view taken along the line A-A as viewed in the direction of arrows.

A composite valve device 1 is constructed as a disc valve module that has functions as a plurality of (three in the illustrated example) three-way valves and is driven by a motor. As illustrated in FIG. 1 to FIG. 3, the composite valve device 1 mainly includes: a valve main body 2 arranged at a lower end portion thereof; a valve portion 3 arranged on top of the valve main body 2; an actuator 4 arranged at an upper end portion thereof; and a sealing portion 5 and a coupling portion 6, which are arranged between the valve portion 3 and the actuator 4.

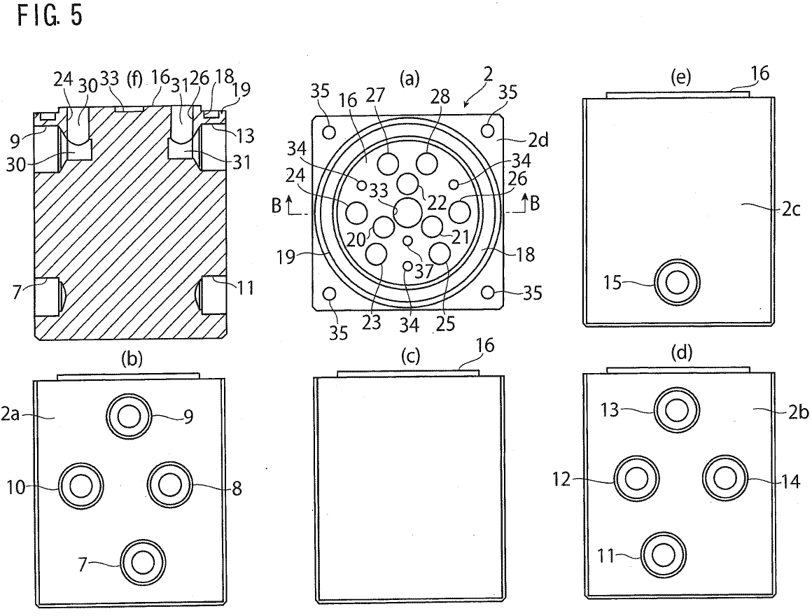

As illustrated in FIG. 1 and FIG. 2, the valve main body 2 is made of a metal such as SUS into a substantially cubic shape or a substantially rectangular parallelepipedo shape. As illustrated in FIG. 5(b), in one side surface (left side surface in the illustrated example) 2a of the valve main body 2, a first introduction port 7, a main outlet port 8, a sub outlet port 9, and a main outlet port 10 are opened. The first introduction port 7 is opened in a lower end portion of the side surface 2a so as to be slightly closer to the right side and allows introduction of a lower temperature fluid as one example of a first fluid. The main outlet port 8 is opened on a right side in an intermediation portion of the side surface 2a and is one of a plurality of (two in the illustrated example) outlet ports that allow the lower temperature fluid introduced through the first introduction port 7 to be branched and discharged. The sub outlet port 9 is opened in a center of an upper end portion of the side surface 2a and is another one of the two outlet ports that allow the lower temperature fluid introduced through the first introduction port 7 to be branched and discharged. The main outlet port 10 is opened on a left side in the intermediation portion and is one of a plurality of (two in the illustrated example) outlet ports that allow a mixed fluid as one example of a third fluid introduced through a third introduction port 15 (see FIG. 5(e)) described later to be branched and discharged.

Further, as illustrated in FIG. 5(d), in another side surface (right side surface in the illustrated example) 2b of the valve main body 2, a second introduction port 11, a main outlet port 12, a sub outlet port 13, and a sub outlet port 14 are opened. The second introduction port 11 is opened in a lower end portion of the side surface 2b so as to be slightly closer to the left side and allows introduction of a higher temperature fluid as one example of a second fluid. The main outlet port 12 is opened on a left side in an intermediation portion of the side surface 2b and is one of a plurality of (two in the illustrated example) outlet ports that allow the higher temperature fluid introduced through the second introduction port 11 to be branched and discharged. The sub outlet port 13 is opened in a center of an upper end portion of the side surface 2b and is another one of the two outlet ports that allow the higher temperature fluid introduced through the second introduction port 11 to be branched and discharged. The sub outlet port 14 is opened on a right side in the intermediation portion and is one of a plurality of (two in the illustrated example) outlet ports that allow a mixed fluid as one example of a third fluid to be branched and discharged.

Further, as illustrated in FIG. 5(e), in the valve main body 2, the third introduction port 15 is opened. The third introduction port 15 is opened in a center of a lower end portion of another side surface (rear surface in the illustrated example) 2c and allows introduction of the mixed fluid as one example of the third fluid. The first introduction port 7, the second introduction port 11, and the third introduction port 15 are formed independently of each other.

Here, for convenience, the terms “main outlet port” and “sub outlet port” are used to distinguish a plurality of (two in the illustrated example) outlet ports and do not mean that any one of the outlet ports is “main” and another one of the outlet ports is “sub” in terms of functions. The same holds true for the term “branching outflow ports” described later.

Each of the introduction ports 7, 11, and 15 and the outlet ports 8, 9, 10, 12, 13, and 14 of the valve main body 2 is formed as, for example, a tapered female thread. However, each of the introduction ports 7, 11, and 15 and the outlet ports 8, 9, 10, 12, 13, and 14 is not limited to a tapered female thread as long as a desired fluid is allowed to be introduced or discharged, and may also be formed of a non-tapered female thread, a cylindrical opening portion having a flange portion, or the like. An identification plate (not shown) for identifying the kind of fluid and whether the port is an introduction port or an outlet port (including whether the outlet port is main or sub) is provided to each of the introduction ports 7, 11, and 15 and the outlet ports 8, 9, 10, 12, 13, and 14.

A pipe (not shown) that allows the lower temperature fluid to be introduced into the valve main body 2 is connected to the first introduction port 7. A pipe (not shown) that allows the higher temperature fluid to be introduced into the valve main body 2 is connected to the second introduction port 11. A pipe (not shown) that allows the mixed fluid to be introduced into the valve main body 2 is connected to the third introduction port 15.

Similarly, pipes (not shown) that allow the lower temperature fluid introduced into the valve main body 2 to be discharged from the valve main body 2 after being branched are connected to the main outlet port 8 and the sub outlet port 9, each for the lower temperature fluid, of the valve main body 2. Pipes (not shown) that allow the higher temperature fluid introduced into the valve main body 2 to be discharged from the valve main body 2 after being branched are connected to the main outlet port 12 and the sub outlet port 13, each for the higher temperature fluid. Pipes (not shown) that allow the mixed fluid introduced into the valve main body 2 to be discharged from the valve main body 2 after being branched are connected to the main outlet port 10 and the sub outlet port 14, each for the mixed fluid.

The lower temperature fluid as the first fluid and the higher temperature fluid as the second fluid are formed of, for example, a fluid used for temperature control. Here, a fluid at a relatively low temperature is referred to as “lower temperature fluid”, and a fluid at a relatively high temperature is referred to as “higher temperature fluid”. Thus, the terms “lower temperature fluid” and “higher temperature fluid” are relative terms and do not refer to a low temperature fluid at an absolutely low temperature or a high temperature fluid at an absolutely high temperature. Further, the mixed fluid is a fluid in which the lower temperature fluid and the higher temperature fluid are mixed at any appropriate ratio (including a case in which any one thereof is zero). As the lower temperature fluid and the higher temperature fluid, for example, fluorine-based inert liquids adaptable within a temperature range of from about −100 °C to about +120 °C under pressure of from 0 MPa to 1 MPa, such as Fluorinert (trademark) (manufactured by 3M Company), Opteon (trademark) (manufactured by Chemours-Mitsui Fluoroproducts Co., Ltd.), and Novec (trademark) (manufactured by 3M Company).

As illustrated in FIG. 5(a), on an upper end surface 2d of the valve main body 2, which is formed in a square shape in plan view, a mounting portion 16, onto which a fixed disc 30 as one example of a fixed-side valve body is to be mounted, is provided. The mounting portion 16 is formed integrally in a columnar shape protruding slightly upward from the upper end surface 2d of the valve main body 2. A receiving groove 18 having an annular shape, which is configured to receive an O-seal 17 (see FIG. 4(b)) or an O-ring is formed in an outer periphery of the mounting portion 16. The O-seal 17 is an O-ring type seal ring excellent in chemical resistance, heat resistance, and cold resistance, which is obtained by completely covering an outer periphery of a core material formed of a silicon rubber, a fluoro-rubber, a stainless-steel spring, or the like with perfluoroalkoxy alkane (PFA), fluorinated ethylene propylene (FEP), or the like. In this embodiment, heat resistance and cold resistance are sometimes collectively referred to as “heat resistance”. An O-ring may be used in place of the O-seal 17. However, it is desired that an O-seal excellent in chemical resistance, heat resistance, and cold resistance be used. Further, a leakage prevention groove 19 having a V-shaped cross section, which is configured to prevent the fluid from leaking to an outside, is formed around an outer periphery of the receiving groove 18 in the upper end surface 2d of the valve main body 2.

As illustrated in FIG. 5(a), a total of nine opening portions, which are a first opening portion 20, a second opening portion 21, a third opening portion 22, a fourth opening portion 23, a fifth opening portion 24, a sixth opening portion 25, a seventh opening portion 26, an eighth opening portion 27, and a ninth opening portion 28, are opened in the mounting portion 16 of the valve main body 2. The first opening portion 20 corresponds to the first introduction port 7. The second opening portion 21 corresponds to the second introduction port 11. The third opening portion 22 corresponds to the third introduction port 15. The fourth opening portion 23 corresponds to the main outlet port 8 for the lower temperature fluid. The fifth opening portion 24 corresponds to the sub outlet port 9 for the lower temperature fluid. The sixth opening portion 25 corresponds to the main outlet port 12 for the higher temperature fluid. The seventh opening portion 26 corresponds to the sub outlet port 13 for the higher temperature fluid. The eighth opening portion 27 corresponds to the main outlet port 10 for the mixed fluid. The ninth opening portion 28 corresponds to the sub outlet port 14 for the mixed fluid. Those first opening portion 20 to ninth opening portion 28 are each formed in a circular shape having the same inner diameter. However, those first opening portion 20 to ninth opening portion 28 are not always required to have the same inner diameter, and may have, for example, different inner diameters for the introduction ports and the outlet ports as long as the opening portions correspond to the introduction ports and the outlet ports. When the same inner diameter is set for all the first opening portion 20 to the ninth opening portion 28, processing (manufacture) of the valve main body 2 is facilitated.

The first opening portion 20 to the ninth opening portion 28 that are opened in the mounting portion 16 of the valve main body 2 are arranged at positions corresponding to a plurality of (three in the illustrated example) inflow ports of the fixed disc 30 and a total of six branching outflow ports, which are formed such that at least two (two in the illustrated example) thereof correspond to each of the inflow ports and allow the fluid flowing in through each of the inflow ports to be branched and flow out therethrough.

More specifically, the first opening portion 20 to the third opening portion 22 are arranged at 120-degree intervals along the same circumference on an inner periphery side on the mounting portion 16 of the valve main body 2. Further, adjacent in the circumferential direction the fourth opening portion 23 to the ninth opening portion 28 are arranged along the same circumference on an outer periphery side on the mounting portion 16 of the valve main body 2 so as to be positioned bilaterally symmetrical and spaced apart from each other with respect to a corresponding one among the first opening portion 20 to the third opening portion 22 in a circumferential direction.

As exemplified in FIG. 5(f), which is a sectional view taken along the line B-B of FIG. 5(a) as viewed in the direction of arrows, regarding the first opening portion 20 to the ninth opening portion 28 that are opened in the mounting portion 16 of the valve main body 2, for example, the fifth opening portion 24 is connected to the sub outlet port 9 for the lower temperature fluid via a passage 30′ that is formed in the valve main body 2 in an intersecting pattern along center axes of the fifth opening portion 24 and the sub outlet port 9 for the lower temperature fluid. Further, the seventh opening portion 26 is connected to the sub outlet port 13 for the higher temperature fluid via a passage 31 that is formed in the valve main body 2 in an intersecting pattern along center axes of the seventh opening portion 26 and the sub outlet port 13 for the higher temperature fluid.

Further, as exemplified in FIG. 4(b), regarding the first opening portion 20 to the third opening portion 22, for example, the third opening portion 22 is connected to the third introduction port 15 for the mixed fluid via a passage 32 that is formed in the valve main body 2 in an intersecting pattern along center axes of the third opening portion 22 and the third introduction port 15 for the mixed fluid.

Similarly, the first opening portion 20 is connected to the first introduction port 7, the second opening portion 21 is connected to the second introduction port 11, the fourth opening portion 23 is connected to the main outlet port 8 for the lower temperature fluid, the sixth opening portion 25 is connected to the main outlet port 12 for the higher temperature fluid, the eighth opening portion 27 is connected to the main outlet port 10 for the mixed fluid, and the ninth opening portion 28 is connected to the sub outlet port 14 for the mixed fluid, each via a passage (not shown) formed in the valve main body 2.

Further, as illustrated in FIG. 5(a), in the mounting portion 16 of the valve main body 2, a support hole 33 is formed in a center thereof. The support hole 33 allows a lower end portion 41a of a movable shaft 41 configured to drive a movable disc 40 described later to rotate, to be rotatably supported in the support hole 33. Further, a plurality of (three in the illustrated example) female thread portions 34 for fixing the fixed disc 30 are formed on an outer periphery of the mounting portion 16 of the valve main body 2. The female thread portions 34 are arranged in the circumferential direction about the support hole 33 at 120-degree intervals. In FIG. 4(b), for convenience, the female thread portion 34 is illustrated as being positioned further on the inner periphery side as compared with the female thread portions 34 of FIG. 5(a). However, positions of the female thread portions 34 may be any of the positions.

As illustrated in FIG. 5(a), female thread portions 35 for mounting a case member 60 described later are formed in four corner portions of the upper end surface 2d of the valve main body 2.

As illustrated in FIG. 4(b), fixing bolts 36 inserted into the fixed disc 30 with their head portions embedded in the fixed disc 30 are fastened into the three female thread portions 34 of the mounting portion 16. Then, the fixed disc 30 is mounted in a state of being fixed onto the mounting portion 16 of the valve main body 2.

In FIG. 5(a), a reference symbol 37 denotes an insertion hole that allows insertion of a positioning pin 38 (see FIG. 4(b)) for positioning the fixed disc 30 onto the mounting portion 16 of the valve main body 2. The positioning pin 38 is arranged on a straight line that connects centers of the third opening portion 22, the support hole 33, and the female thread portion 34 in a diametrical direction. In this manner, the fixed disc 30 can be mounted onto the mounting portion 16 of the valve main body 2 under a state in which the fixed disc 30 is accurately positioned with respect to the mounting portion 16. In FIG. 5(a) and FIG. 4(b), positions of the insertion hole 37 and the positioning pin 38 are different for illustration purposes. However, it is apparent that the positioning pin 38 may be arranged on any one of an inner periphery or an outer periphery with respect to the female thread portions 34.

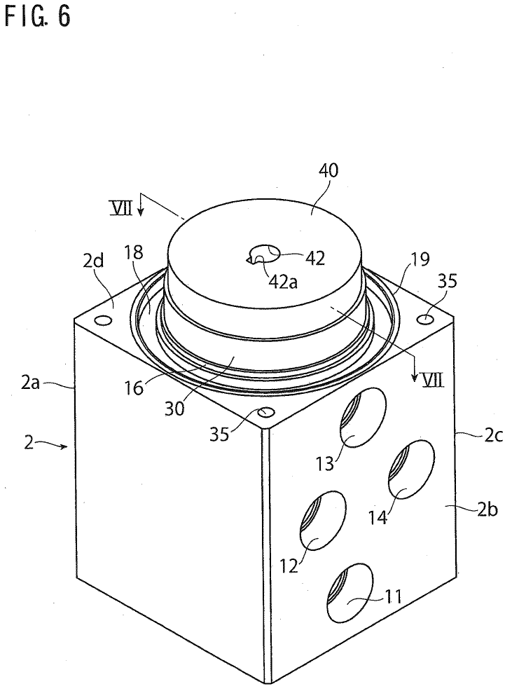

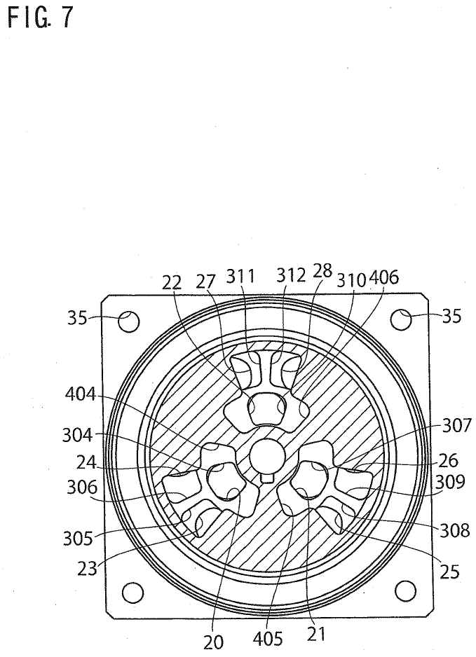

As illustrated in FIG. 6, the fixed disc 30 is mounted on the mounting portion 16 of the valve main body 2 as described above. The movable disc 40 is arranged in a state of being stacked on top of the fixed disc 30. FIG. 7 is a sectional view taken along the line VII-VII of FIG. 6 as viewed in the direction of arrows.

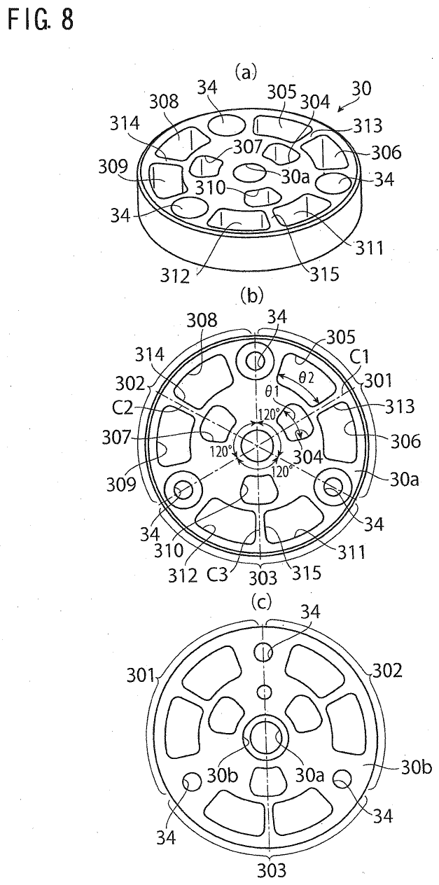

As illustrated in FIG. 8(a) to FIG. 8(c), the fixed disc 30 is made of a ceramic such as alumina or a metal such as SUS and is formed in a flat sheet shape (disc shape) being circular in plan view and having a required thickness. The fixed disc 30 has an upper end surface 30a and a lower end surface 30b, each formed flat. As a material for the fixed disc 30, it is desired to use a ceramic such as alumina in view of heat resistance, durability, and the like so as to deal with a fluid at a temperature varying within a temperature range of from about −100 °C to about +120 °C. The upper end surface 30a and the lower end surface 30b of the fixed disc 30 are formed with significantly high smoothness. The fixed disc 30 is configured to prevent leakage of a fluid when being arranged and fixed in a state of being stacked on and under other members to be in close contact with an upper end surface of the mounting portion 16 of the valve main body 2, which is arranged thereunder, and a lower end surface of the movable disc 40, which is arranged thereon.

The fixed disc 30 is a member serving as one of valve bodies, together with the movable disc 40 as one example of a movable valve body described later, in the plurality of (three in the illustrated example) three-way valves.

As illustrated in FIG. 8(b), the fixed disc 30 is segmented into a first valve region 301, a second valve region 302, and a third valve region 303 corresponding to three three-way valves. The first valve region 301 corresponds to, for example, a three-way valve for the lower temperature fluid. The second valve region 302 corresponds to a three-way valve for the higher temperature fluid. The third valve region 303 corresponds to a three-way valve for the mixed fluid. The first valve region 301 to the third valve region 303 are set by trisecting the fixed disc 30 in the circumferential direction into fan-shaped regions, each having a central angle of 120 degrees about a center of the fixed disc 30.

As illustrated in FIG. 5 and FIG. 7, an orientation in which the fixed disc 30 is mounted on the mounting portion 16 of the valve main body 2 is such that the first valve region 301 for the lower temperature fluid is positioned on a diagonally lower left in the drawing, the second valve region 302 for the higher temperature fluid is positioned on a diagonally lower right in the drawing, and the third valve region 303 for the mixed fluid is positioned in an upper end portion in the drawing.

In the first valve region 301 of the fixed disc 30, a first inflow port 304, a main low temperature outflow port 305, and a sub low temperature outflow port 306 are opened as a three-way valve for the lower temperature fluid. The first inflow port 304 as one example of a flow port allows inflow of the lower temperature fluid as the first fluid. The main low temperature outflow port 305 and the sub low temperature outflow port 306 are one example of branching outflow ports (branching/mixing flow ports), which are formed such that at least two (two in the illustrated example) thereof correspond to the first inflow port 304, and which allow the lower temperature fluid that has flowed in through the first inflow port 304 to be branched and flow out. The main low temperature outflow port 305 and the sub low temperature outflow port 306 are arranged so that the main low temperature outflow port 305 is positioned on an upstream side in a clockwise direction and the sub low temperature outflow port 306 is positioned on a downstream side in the clockwise direction, with respect to the center of the fixed disc 30.

Similarly, in the second valve region 302 of the fixed disc 30, a second inflow port 307, a main high temperature outflow port 308, and a sub high temperature outflow port 309 are opened as a three-way valve for the higher temperature fluid. The second inflow port 307 as one example of a flow port allows inflow of the higher temperature fluid as the second fluid. The main high temperature outflow port 308 and the sub high temperature outflow port 309 are one example of at least two (two in the illustrated example) branching outflow ports (branching/mixing flow ports) that correspond to the second inflow port 307. The main high temperature outflow port 308 and the sub high temperature outflow port 309 are arranged so that the sub high temperature outflow port 309 is positioned on the upstream side in the clockwise direction and the main high temperature outflow port 308 is positioned on the downstream side in the clockwise direction, with respect to the center of the fixed disc 30. The arrangement of the main high temperature outflow port 308 and the sub high temperature outflow port 309 in the clockwise direction is in a reverse order to that of the main low temperature outflow port 305 and the sub low temperature outflow port 306 in terms of the main outflow port and the sub outflow port. This arrangement is not only used in view of a way of using the composite valve device 1, connection of pipes, and the like, but is also used to, when the lower temperature fluid and the higher temperature fluid are used as two fluids, simultaneously change a flow rate of the lower temperature fluid being one of the two fluids from 100% to 0% and change a flow rate of the higher temperature fluid being another one of the fluids from 0% to 100% by driving the movable disc 40 to rotate.

In addition, in the third valve region 303 of the fixed disc 30, a third inflow port 310, a main mixture outflow port 311, and a sub mixture outflow port 312 are opened as a three-way valve for the mixed fluid. The third inflow port 310 as one example of a flow port allows inflow of the mixed fluid as the third fluid. The main mixture outflow port 311 and the sub mixture outflow port 312 are one example of at least two (two in the illustrated example) branching outflow ports (branching/mixing flow ports) that correspond to the third inflow port 310. The main mixture outflow port 311 and the sub mixture outflow port 312 are arranged so that the main mixture outflow port 311 is positioned on the upstream side in the clockwise direction and the sub mixture outflow port 312 is positioned on the downstream side in the clockwise direction, with respect to the center of the fixed disc 30. This arrangement is the same as that of the main low temperature outflow port 305 and the sub low temperature outflow port 306.

When the number of inflow ports is represented by N (=3), the first inflow port 304, the second inflow port 307, and the third inflow port 310, each formed in the same shape, are arranged at positions obtained by equally dividing the fixed disc 30 by N in a circumferential direction on an inner periphery side in a radial direction of the fixed disc 30 so as to form 120-degree angles therebetween on a circumference having the same radius.

The first inflow port 304, the second inflow port 307, and the third inflow port 310 are arranged on a concentric circle on the inner periphery side in the radial direction of the fixed disc 30. The first inflow port 304, the second inflow port 307, and the third inflow port 310 are each formed in a fan-like shape having a required central angle θ1 and a required length in the radial direction with respect to center lines C1 to C3 of the first valve region 301 to the third valve region 303 in the circumferential direction.

Further, the main low temperature outflow port 305 and the sub low temperature outflow port 306, the main high temperature outflow port 308 and the sub high temperature outflow port 309, and the main mixture outflow port 311 and the sub mixture outflow port 312 are arranged on a concentric circle on an outer periphery side with respect to the first inflow port 304, the second inflow port 307, and the third inflow port 310 in the radial direction of the fixed disc 30. The main low temperature outflow port 305 and the sub low temperature outflow port 306, the main high temperature outflow port 308 and the sub high temperature outflow port 309, and the main mixture outflow port 311 and the sub mixture outflow port 312 are arranged at bilaterally symmetrical positions with respect to the center lines C1 to C3 of the first valve region 301 to the third valve region 303 in the circumferential direction, and are each formed in a fan-like shape having a required central angle θ2 larger than that of the first inflow port 304, the second inflow port 307, and the third inflow port 310 and a required length in the radial direction, which is substantially equal to that of the first inflow port 304, the second inflow port 307, and the third inflow port 310 in the radial direction.

The first inflow port 304, the second inflow port 307, and the third inflow port 310 are opened so as to penetrate the fixed disc 30 in a thickness direction. Corner portions are each formed in an R (curved) shape having a required radius of curvature when the first inflow port 304, the second inflow port 307, and the third inflow port 310 are seen in plan view. The corner portions each formed in an R (curved) shape when the first inflow port 304, the second inflow port 307, and the third inflow port 310 are seen in plan view enable prevention of concentration of thermal stress, which is generated along with a temperature change, on the corner portions of the first inflow port 304, the second inflow port 307, and the third inflow port 310 when a fluid at a temperature varying within a range of from about −100 °C to about +1200 °C flows into the inflow ports 304, 307, and 310.

Similarly, the main low temperature outflow port 305 and the sub low temperature outflow port 306, the main high temperature outflow port 308 and the sub high temperature outflow port 309, and the main mixture outflow port 311 and the sub mixture outflow port 312 are opened so as to penetrate the fixed disc 30 in the thickness direction. Corner portions are each formed in an R (curved) shape having a required radius of curvature when the main low temperature outflow port 305 and the sub low temperature outflow port 306, the main high temperature outflow port 308 and the sub high temperature outflow port 309, and the main mixture outflow port 311 and the sub mixture outflow port 312 are seen in plan view. Further, the main low temperature outflow port 305 and the sub low temperature outflow port 306, the main high temperature outflow port 308 and the sub high temperature outflow port 309, and the main mixture outflow port 311 and the sub mixture outflow port 312 are separated from each other by a first partition wall 313 to a third partition wall 315, each having a required thickness, with respect to the center lines C1 to C3, respectively.

In the fixed disc 30, as illustrated in FIG. 7, the first inflow port 304 is arranged at a position corresponding to the first opening portion 20 in the mounting portion 16 of the valve main body 2; the second inflow port 307 is arranged at a position corresponding to the second opening portion 21 in the mounting portion 16 of the valve main body 2; and the third inflow port 310 is arranged at a position corresponding to the third opening portion 22 in the mounting portion 16 of the valve main body 2.

Thus, the lower temperature fluid that has flowed in through the first opening portion 20 in the mounting portion 16 of the valve main body 2 flows into the first inflow port 304 of the fixed disc 30; the higher temperature fluid that has flowed in through the second opening portion 21 flows into the second inflow port 307 of the fixed disc 30; and the mixed fluid that has flowed in through the third opening portion 22 flows into the third inflow port 310 of the fixed disc 30.

Similarly, in the fixed disc 30, as illustrated in FIG. 7, the main low temperature outflow port 305 is arranged at a position corresponding to the fourth opening portion 23 in the mounting portion 16 of the valve main body 2; the sub low temperature outflow port 306 is arranged at a position corresponding to the fifth opening portion 24 in the mounting portion 16 of the valve main body 2; the main high temperature outflow port 308 is arranged at a position corresponding to the sixth opening portion 25 in the mounting portion 16 of the valve main body 2; the sub high temperature outflow port 309 is arranged at a position corresponding to the seventh opening portion 26 in the mounting portion 16 of the valve main body 2; the main mixture outflow port 311 is arranged at a position corresponding to the eighth opening portion 27 in the mounting portion 16 of the valve main body 2; and the sub mixture outflow port 312 is arranged at a position corresponding to the ninth opening portion 28 in the mounting portion 16 of the valve main body 2.

A main lower temperature fluid that has flowed out through the main low temperature outflow port 305 of the fixed disc 30 flows out through the fourth opening portion 23 in the mounting portion 16 of the valve main body 2; a sub lower temperature fluid that has flowed out through the sub low temperature outflow port 306 flows out through the fifth opening portion 24 in the mounting portion 16 of the valve main body 2; a main higher temperature fluid that has flowed out through the main high temperature outflow port 308 flows out through the sixth opening portion 25 in the mounting portion 16 of the valve main body 2; a sub higher temperature fluid that has flowed out through the sub high temperature outflow port 309 flows out through the seventh opening portion 26 in the mounting portion 16 of the valve main body 2; a main mixed fluid that has flowed out through the main mixture outflow port 311 flows out through the eighth opening portion 27 in the mounting portion 16 of the valve main body 2; and a sub mixed fluid that has flowed out through the sub mixture outflow port 312 flows out through the ninth opening portion 28 in the mounting portion 16 of the valve main body 2.

As illustrated in FIG. 6 and FIG. 7, on top of the fixed disc 30, the movable disc 40 as one example of a movable valve body is arranged in a rotatably stacked state as one movable form so as to be in close contact with the upper end surface 30a of the fixed disc 30.

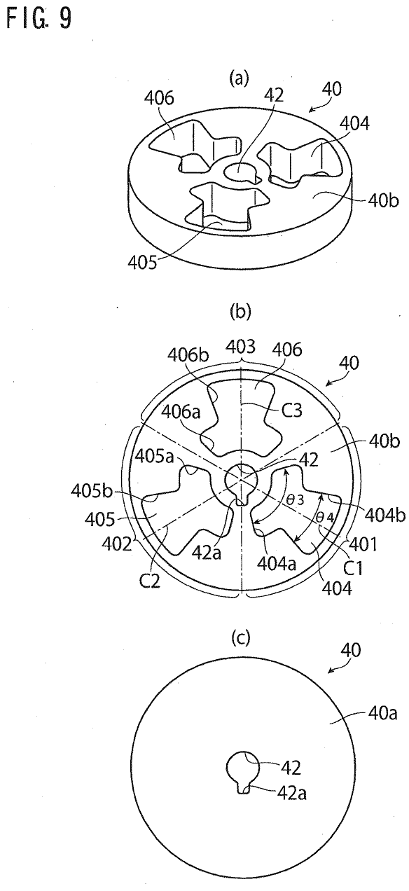

As illustrated in FIG. 9(a) to FIG. 9(c), the movable disc 40 is made of a ceramic such as alumina or a metal such as SUS and is formed in a flat sheet shape (disc shape) being circular in plan view and having a required thickness. The movable disc 40 has an upper end surface 40a and a lower end surface 40b, each being formed flat. As a material for the movable disc 40, it is desired to use a ceramic such as alumina in view of heat resistance, durability, and the like, similarly to the fixed disc 30. The upper end surface 40a and the lower end surface 40b of the movable disc 40 are formed with significantly high smoothness. The movable disc 40 is configured to prevent leakage of a fluid when being arranged and fixed in a state of being stacked on and under other members to be in close contact with the upper end surface 30a of the fixed disc 30, which is arranged thereunder.

As illustrated in FIG. 9, in the movable disc 40, an insertion hole 42 with a key groove 52a, which allows insertion of the movable shaft 41 serving as a center axis, is opened. As illustrated in FIG. 4(b), in a center of the movable disc 40, the movable shaft 41 is mounted in a state of being fixed through intermediation of a parallel key 43. The parallel key 43 is fixed to the movable shaft 41 with a set screw 44. The lower end portion 41a of the movable shaft 41 passes through a through hole 30c of the fixed disc 30 and is rotatably supported in the support hole 33 of the valve main body 2 through intermediation of a bearing member 45. The through hole 30c of the fixed disc 30 has a lower end portion 30d that is formed with a larger inner diameter so as to receive the bearing member 45. The movable disc 40 is driven to rotate in a required direction over a required angle by the actuator 4 through intermediation of the movable shaft 41.

As illustrated in FIG. 9(b), the movable disc 40 is segmented into a first valve region 401, a second valve region 402, and a third valve region 403 corresponding to three three-way valves. The first valve region 401 corresponds to, for example, a three-way valve for the lower temperature fluid. The second valve region 402 corresponds to a three-way valve for the higher temperature fluid. The third valve region 403 corresponds to a three-way valve for the mixed fluid. The first valve region 401 to the third valve region 403 are set by trisecting the movable disc 40 in the circumferential direction into fan-shaped regions, each having a central angle of 120 degrees about a center of the movable disc 40.

The movable disc 40 is constructed to have a plurality of (three in the illustrated example) variable communication paths 404 to 406 in the lower end surface 40b thereof. Each of the variable communication paths 404 to 406 allows communication of each of the inflow ports of the fixed disc 30 with at least two (two in the illustrated example) branching outflow ports corresponding thereto so that a fluid is branched at a variable branching ratio. The variable communication paths 404 to 406 are opened only on the lower end surface 40b side of the movable disc 40 and are closed on the upper end surface 40a side of the movable disc 40.

The variable communication paths 404 to 406 of the movable disc 40 are formed in the same manner.

Now, the first variable communication path 404 is described as an example. In the first valve region 401 of the movable disc 40, the variable communication path 404 on the low temperature side is formed on the lower end surface side. The variable communication path 404 allows communication of the first inflow port 304 of the fixed disc 30 with two outflow ports corresponding thereto, which are the main low temperature outflow port 305 and the sub low temperature outflow port 306, so that the lower temperature fluid as the first fluid is branched at a variable branching ratio.

The variable communication path 404 on the low temperature side is formed with an inner-periphery-side communication portion 404a and an outer-periphery-side communication portion 404b. The inner-periphery-side communication portion 404a is arranged on an inner periphery side in a radial direction of the movable disc 40 and is constantly in communication with the first inflow port 304 of the fixed disc 30. The outer-periphery-side communication portion 404b is arranged on an outer periphery side in the radial direction of the movable disc 40 and is selectively or simultaneously brought into communication with the main low temperature outflow port 305 and the sub low temperature outflow port 306 of the fixed disc 30. An end portion of the outer-periphery-side communication portion 404b on the inner periphery side in the radial direction of the movable disc 40 is connected to the inner-periphery-side communication portion 404a. Thus, a fluid that has flowed in through the inner-periphery-side communication portion 404a flows into the outer-periphery-side communication portion 404b.

The inner-periphery-side communication portion 404a of the movable disc 40 is formed in a fan-like shape that has a large central angle θ3 and a length equal to that of the first inflow port 304 in the radial direction so as to be constantly kept in communication with the first inflow port 304 of the fixed disc 30, which corresponds thereto, even when the movable disc 40 is rotated.

Further, the outer-periphery-side communication portion 404b of the movable disc 40 is formed in a fan-like shape that has a central angle θ4 (=θ2 ) equal to those of the main low temperature outflow port 305 and the sub low temperature outflow port 306 and a length in the radial direction longer than those of the main low temperature outflow port 305 and the sub low temperature outflow port 306 so as to be selectively or simultaneously brought into communication with the main low temperature outflow port 305 and the sub low temperature outflow port 306 of the fixed disc 30 when the movable disc 40 is rotated.

In the movable disc 40, as illustrated in FIG. 7, for example, as reference positions (home positions), the variable communication path 404 for the low temperature fluid is arranged at a position corresponding to the first inflow port 304 of the fixed disc 30, the variable communication path 405 for the high temperature fluid is arranged at a position corresponding to the second inflow port 307 of the fixed disc 30, and the variable communication path 406 for the mixed fluid is arranged at a position corresponding to the third inflow port 310 of the fixed disc 30.

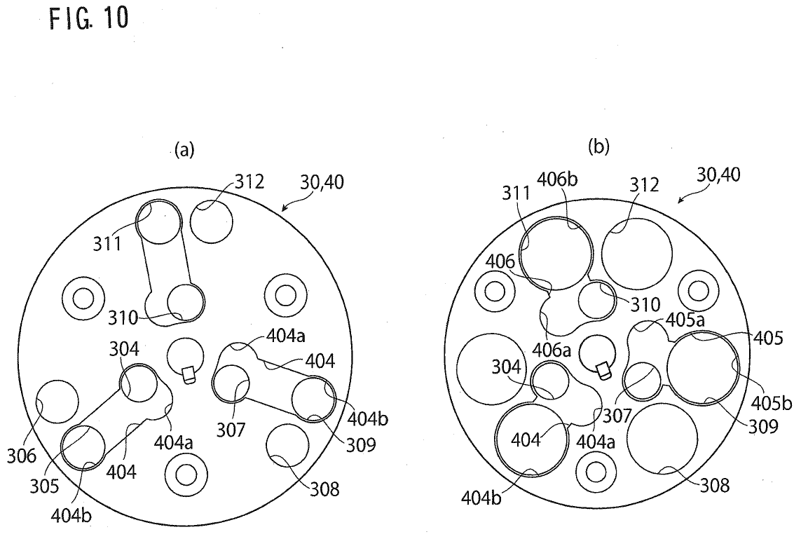

In the first embodiment illustrated in the drawings, the inflow ports and the outflow ports of the fixed disc and the variable communication paths of the movable disc, each being formed in a fan-like shape, have been described. However, shapes of those inflow ports and outflow ports of the fixed disc and those variable communication paths of the movable disc are not limited to a fan-like shape, and may be a circular shape as illustrated in FIG. 10. FIG. 10 each schematically show a state in which the fixed disc 30 and the movable disc 40 are stacked.

On top of the movable disc 40, as illustrated in FIG. 3 and FIG. 4(b), a wave washer seating plate 50, a wave washer 51, and a wave washer retainer 52 are arranged in a stacked state.

The wave washer seating plate 50 is a sheet-shaped member made of a metal such as SUS, which has a circular shape in plan view. The wave washer seating plate 50 is arranged in a stacked state on the upper end surface 40a of the movable disc 40, and is used to uniformly apply a pressing force of the wave washer 51 onto the upper end surface 40a of the movable disc 40. As illustrated in FIG. 3, an insertion hole 501 that allows insertion of the movable shaft 41 is opened in a center of the wave washer seating plate 50. Further, as illustrated in FIG. 4(b), the wave washer seating plate 50 is positioned and fixed onto the movable disc 40 by a positioning pin 502.

The wave washer 51 is made of a metal material having springiness (elasticity) such as phosphor bronze, and is formed by deforming a flat sheet having a circular shape in plan view to have a plurality of corrugated patterns (wave patterns) in a circumferential direction. The wave washer 51 is a member configured to achieve close contact of the lower end surface 40b of the movable disc 40 with the upper end surface 30a of the fixed disc 30 by pressing the upper end surface 40a of the movable disc 40. The wave washer 51 can acquire a desired elastic restoring force (pressing force) in a thickness direction by appropriately setting a material, an outer diameter, a thickness, the number and a height of corrugated patterns (wave patterns), and the like. In the wave washer 51, an insertion hole 511 that allows insertion of the movable shaft 41 is opened in a center.

The wave washer retainer 52 is a sheet-shaped member having a circular shape in plan view, which is made of a metal such as SUS with a required thickness and is provided in a state of being fixed to the movable shaft 41. A position of the wave washer retainer 52, which is fixed to the movable shaft 41, is regulated in an up-and-down direction. When retaining the wave washer 51, the wave washer retainer 52 generates a required pressing force.

As illustrated in FIG. 4(b), the members configured as described above, which are the fixed disc 30, the movable disc 40, the wave washer seating plate 50, the wave washer 51, and the wave washer retainer 52, are accommodated in the case member 60.

As illustrated in FIG. 3, the case member 60 is made of a metal such as SUS, and is formed in a cylindrical shape having an upper end surface 61 and a flange portion 62. The upper end surface 61 is formed with a large thickness, and is closed. The flange portion 62 has a rectangular shape in plan view, and is provided integrally with an outer periphery of a lower end portion.

As illustrated in FIG. 3 and FIG. 4, the case member 60 is fixed onto the upper end surface of the valve main body 2 with fixing bolts 64 inserted into insertion holes 63 that are formed in four corner portions of the flange portion 62. Inside the case member 60, a space 65 for easing a thermal influence of the valve main body 2 on the actuator 4 particularly at an extremely low temperature of about −100 °C is defined under a ceiling portion.

As illustrated in FIG. 3, the case member 60 has an opening portion H in a side surface of the flange portion 62. When a liquid leaks from an inside of the case member 60, the opening portion H allows the leaking liquid to be found.

The upper end surface 61 of the case member 60 forms the sealing portion 5 configured to seal an intermediate portion 41b of the movable shaft 41 in a liquid-tight state.

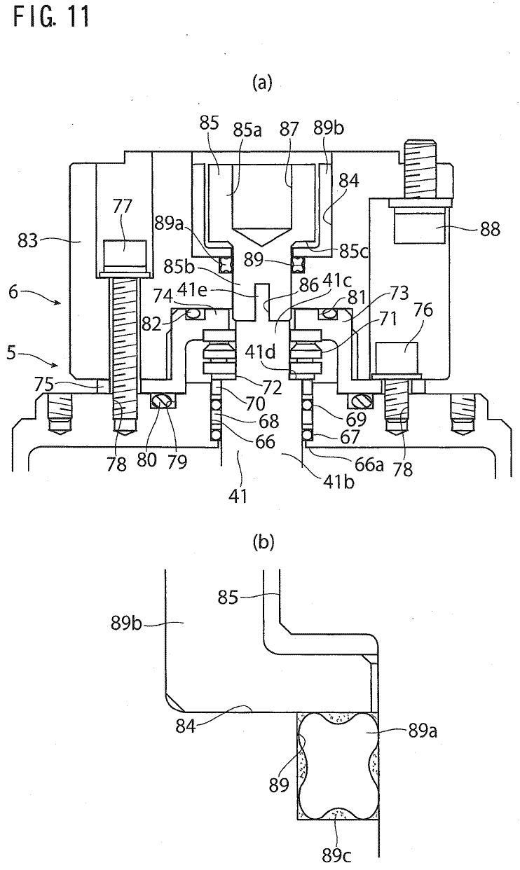

As illustrated in FIG. 11, in the upper end surface 61 of the case member 60, which forms the sealing portion 5, an insertion hole 66 that allows insertion of the movable shaft 41 is opened. A flange portion 66a having an annular shape is formed at a lower end portion of the insertion hole 66 so as to project radially inward. An inner diameter of the insertion hole 66 is set larger than an outer diameter of the intermediate portion 41b of the movable shaft 41. A first omniseal 67 opening downward, a first bearing member 68, a second omniseal 69 similarly opening downward, and a second bearing member 70 are arranged between the insertion hole 66 and the movable shaft 41 in the stated order from a lower side.

Those first omniseal 67 and second omniseal 69 and first bearing member 68 and second bearing member 70 are members configured to rotatably seal the intermediate portion 41b of the movable shaft 41 in a liquid-tight (air-tight) state.

An upper end portion 41c of the movable shaft 41 is formed with an outer diameter smaller than that of the intermediate portion 41b. A level difference portion 41d is formed between the upper end portion 41c and the intermediate portion 41b.

A thrust bearing 71 configured to support the movable shaft 41 in an axial direction is arranged around the upper end portion 41c of the movable shaft 41. The thrust bearing 71 is in abutment against the level difference portion 41d of the movable shaft 41 with the presence of an annular member 7 therebetween and regulates a position of the movable shaft 41 in the axial direction. The thrust bearing 71 is accommodated in a bearing holder 73 under a state in which its vertical position is fixed.

As illustrated in FIG. 11, the bearing holder 73 is made of a metal such as SUS, and is formed in a cylindrical shape having an upper end surface 74 and a flange portion 75. The upper end surface 74 is closed. The flange portion 75 has a circular shape in plan view and is provided integrally with an outer periphery of a lower end portion of the bearing holder 73. Together with a coupling member (including a spacer member 83), the flange portion 75 of the bearing holder 73 is fastened and fixed onto the upper end surface 61 of the case member 60 with a plurality of fixing bolts 76 and 77 having different lengths. A plurality of female thread portions 78 corresponding to the plurality of fixing bolts 76 and 77 are formed in the upper end surface 61 of the case member 60.

The flange portion 75 of the bearing holder 73 is sealed with an O-ring 80 received in a recessed groove 79 formed in the upper end surface 61 of the case member 60. Further, the upper end surface 74 of the bearing holder 73 is sealed with respect to the spacer member 83 with an O-ring 82 received in a recessed groove 81 formed in the upper end surface 74.

As illustrated in FIG. 1, the coupling portion 6 as one example of joining means is arranged between the valve portion 3, in which the sealing portion 5 is provided, and the actuator 4. The coupling portion 6 is configured to couple and fix the case member 60, in which the sealing portion 5 is provided, and the actuator 4 to each other, and also to couple the movable shaft 41 to a rotary shaft (not shown) of the actuator 4 that drives the movable shaft 41 to rotate.

As illustrated in FIG. 11, the coupling portion 6 includes the spacer member 83 and a coupling member 85. The spacer member 83 is arranged between the valve portion 3 and the actuator 4. The coupling member 85 is one example of driving-force transmission means for coupling the movable shaft 41 and the rotary shaft (not shown) to each other, which is accommodated in a space 84 having a columnar shape that is defined in a state of extending through an inside of the spacer member 83. The spacer member 83 is made of a synthetic resin such as a polyimide (PI) resin and is formed in a cylindrical shape having an outer diameter smaller than that of the case member 60 and a large thickness. The spacer member 83 has a lower end and an intermediate portion, which are mounted on the upper end surface 61 of the case member 60 in a fixed state with the fixing bolts 76 and 77.

An upper end 41e of the movable shaft 41 is formed in an upwardly protruding flat sheet shape. The upper end 41e of the movable shaft 41 is coupled and fixed by being fitted into a recessed groove 86 formed in a lower end portion of the coupling member 85. Meanwhile, an insertion hole 87 that allows insertion of a quadrangular prismatic lower end portion of a drive shaft (not shown) of the actuator 4 is formed in an upper end of the coupling member 85.

An upper end portion 85a of the coupling member 85 is formed with an outer diameter larger than that of a lower end portion 85b. A level difference portion 85c facing downward is formed between the upper end portion 85a and the lower end portion 85b. The space 84 having a columnar shape in which the coupling member 85 is accommodated is formed so as to conform with a shape of the coupling member 85. A receiving groove 89 in which an X-ring 89a as one example of sealing means is allowed to be received is formed at a position corresponding to a boundary between the upper end portion 85a and the lower end portion 85b of the coupling member 85 in the space 84. Further, a holding member 89b is arranged on an outer periphery of the upper end portion 85a of the coupling member 85. The holding member 89b is accommodated in the space 84 under a state in which the coupling member 85 is inserted through the holding member 89b, to thereby hold the X-ring 89a. A lubricant 89c is applied to the X-ring 89a as required.

As illustrated in FIG. 11, the spacer member 83 is mounted in a state of being fixed onto a lower end surface of the actuator 4 with a plurality of fixing bolts 88.

As illustrated in FIG. 1 and FIG. 2, the actuator 4 as one example of drive means includes a housing 90 formed in a substantially rectangular parallelepiped shape. Inside the housing 90, a stepping motor (or a servomotor) as one example of a drive source configured to drive the movable shaft 41 to rotate, an encoder, a control circuit, and the like are provided. The actuator 4 is only required to be capable of rotating the rotary shaft (not shown) in a desired direction with predetermined accuracy based on control signals, and the configuration thereof is not limited. The drive means includes a stepping motor or the like, a driving force transmission mechanism, and an angle sensor. The driving force transmission mechanism is configured to transmit a rotational driving force of the stepping motor or the like to the rotary shaft through intermediation of driving force transmission means, for example, a gear. The angle sensor is, for example, an encoder or the like configured to detect a rotation angle of the rotary shaft.

In FIG. 2, a reference symbol 91 denotes a stepping motor-side cable, and a reference symbol 92 denotes an angle sensor-side cable. The stepping motor-side cable 91 and the angle sensor-side cable 92 are connected to a control device (not shown) configured to control the composite valve device 1.

As described above, the composite valve device 1 according to the first embodiment assumes the use of a fluorine-based inert liquid adaptable to an extremely low temperature range, which is significantly as low as about −100 °C, such as Opteon (trademark) (manufactured by Chemours-Mitsui Fluoroproducts Co., Ltd.) or Novec (trademark) (manufactured by 3M Company), as a fluid.

Thus, when the composite valve device 1 switches a flow rate of the fluid at a significantly low temperature of about −100 °C, the valve main body 2, the valve portion 3, and the like also have a significantly low temperature of about −100 °C, which is equal to the temperature of the fluid. The valve portion 3 is in contact with the actuator 4 with the presence of the spacer member 83 therebetween. When the valve portion 3 has a low temperature of about −100 °C, it is expected that a temperature of the actuator 4 drops to a temperature close to −100 °C through thermal conduction via the spacer member 83 and the coupling member 85 even when an environmental temperature at which the composite valve device 1 is used is room temperature of from about +20 °C to about +25 °C.

The actuator 4 includes a drive motor, a control circuit, an angle sensor, and the like. The drive motor is configured to drive a valve shaft to rotate, and is formed of a stepping motor or the like. The control circuit is configured to control rotational driving of the drive motor, and is formed of an IC or the like. The angle sensor is configured to detect a rotation angle of the valve shaft. When the actuator 4 is exposed to a significantly low temperature of −100 °C, malfunction of the drive motor formed of a stepping motor or the like and the control circuit formed of an IC or the like may be caused. As a result, it may be difficult to control the flow rate of the fluid under an extremely low temperature of about −100 °C.

Thus, the composite valve device 1 according to the first embodiment is configured so that the driving-force transmission means and the joining means, which are made of a material having a thermal conductivity smaller than those of the valve main body and the valve body, form a heat-transfer suppressing portion configured to suppress heat transfer to the drive means.

Further, the composite valve device 1 according to the first embodiment is configured so that the driving-force transmission means has a thermal conductivity of 10 (W/m·K) or less and the joining means has a thermal conductivity of 1 (W/m·K) or less.

That is, in the composite valve device 1 according to the first embodiment, the spacer member 83 and the coupling member 85 are made of a material having a thermal conductivity smaller than those of the valve main body 2 and the movable shaft 41 to thereby form the heat-transfer suppressing portion configured to suppress heat transfer to the drive means.

The spacer member 83 is made of a synthetic resin having a thermal conductivity smaller than that of SUS for forming the valve main body 2 and the movable shaft 41, such as a polyimide (PI) resin, polytetrafluoroethylene (PTFE), a polyamide imide (PAI) resin, ultra high molecular weight polyethylene (UHMW-PE), a polyamide (PA) resin, or polyacetal (POM). Further, the coupling member 85 is made of zirconia, a ceramic, or the like. A thermal conductivity of polyimide (PI) is 1 (W/m·K) or less, specifically, about 0.16 (W/m·K). Further, mechanical strength (bending strength) of polyimide (PI) is about 170 MPa. Meanwhile, a thermal conductivity of zirconia is 10 (W/m·K) or less, specifically, from 2.7 (W/m·K) to 3.0 (W/m·K). A thermal conductivity of a ceramic is from about 4.0 (W/m·K) to about 10.0 (W/m·K). Further, mechanical strength (bending strength) of zirconia is from about 600 MPa to about 1, 400 MPa. A thermal conductivity of stainless steel is from about 12.8 (W/m·K) to about 26.9 (W/m·K).

### Environmental Conditions

As described above, the composite valve device 1 according to the first embodiment is configured so as to be usable for a fluid at a temperature of, for example, from about −100 °C to about +120 °C, in particular, an extremely low temperature of about −100 °C. Thus, it is desired that ambient environmental conditions under which the composite valve device 1 is used correspond to a temperature range of from −100 °C to about +120 °C. That is, in the composite valve device 1, when a fluid at about −100 °C is caused to flow, the valve main body 2 and the valve portion 3 themselves have a temperature equal to about −100 °C, which is the temperature of the fluid. As a result, when the composite valve device 1 is used under an environment having humidity, which is water in the air, it is considered that the water in the air, which adheres to the composite valve device 1, freezes and causes malfunction of the composite valve device 1.

Accordingly, as the environmental conditions under which the composite valve device 1 is used, it is desired that an ambient humidity (relative humidity) be 0.10% or less, preferably about 0.01% under a nitrogen (N²⁻)-gas-substituted environment.

### Operation of Composite Valve Device

In the composite valve device 1 according to the first embodiment, flow rates of the lower temperature fluid, the higher temperature fluid, and the mixed fluid are controlled in the following manner.

To the valve main body 2 of the composite valve device 1, as illustrated in FIG. 1 and FIG. 4, the lower temperature fluid adjusted to a predetermined lower-temperature-side set temperature, the higher temperature fluid adjusted to a predetermined higher-temperature-side set temperature, and the mixed fluid in which the lower temperature fluid and the higher temperature fluid are mixed are supplied through pipes (not shown) via the first introduction port 7, the second introduction port 11, and the third introduction port 15, respectively.

As illustrated in FIG. 5, the lower temperature fluid that has been supplied into the valve main body 2 via the first introduction port 7 is guided to the first opening portion 20 via the passage (not shown) connected to the first introduction port 7. As illustrated in FIG. 7, the lower temperature fluid that has been guided to the first opening portion 20 of the valve main body 2 flows into the first inflow port 304 of the fixed disc 30.

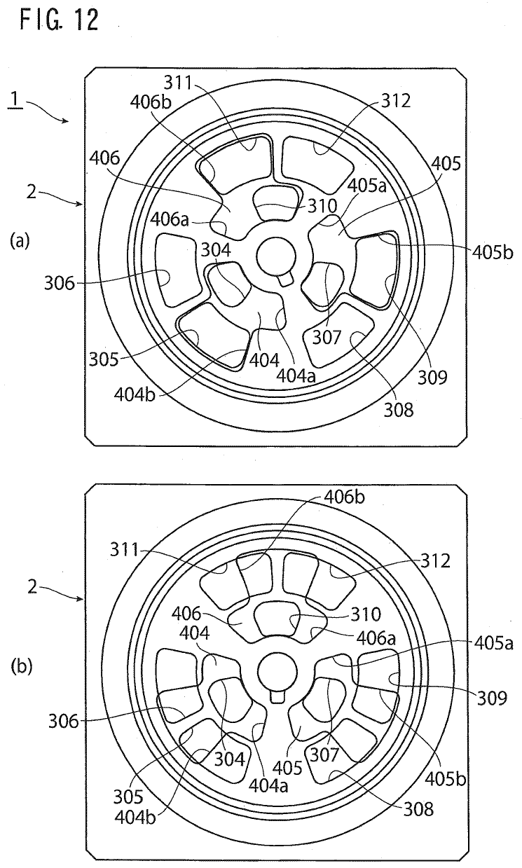

Then, as illustrated in FIG. 12, the lower temperature fluid that has flowed into the first inflow port 304 of the fixed disc 30 flows out of the main low temperature outflow port 305 and/or the sub low temperature outflow port 306 of the fixed disc 30 via the variable communication path 404 on the low temperature side of the movable disc 40.

Now, as illustrated in FIG. 12(a), it is assumed that the movable disc 40 is located at such a position that the outer-periphery-side communication portion 404b of the variable communication path 404 is opposed to only the main low temperature outflow port 305 of the fixed disc 30.

The movable disc 40 is stopped after being driven by the actuator 4 to rotate by a desired rotation amount in a desired rotating direction.

At this time, the movable disc 40 is stopped at such a position that an outer-periphery-side communication portion 405b of the variable communication path 405 for the high temperature fluid is opposed to only the sub high temperature outflow port 309 of the fixed disc 30 and an outer-periphery-side communication portion 406b of the variable communication path 406 for a branched fluid is opposed to only the main mixture outflow port 311 of the fixed disc 30.

Thus, the lower temperature fluid that has flowed in through the first inflow portion 304 of the fixed disc 30 flows through the variable communication path 404 of the movable disc 40 to flow out through its inner-periphery-side communication portion 404a into the outer-periphery-side communication portion 404b and then all (100%) of the lower temperature fluid flows from the outer-periphery-side communication portion 404b to flow out through the main low temperature outflow port 305 of the fixed disc 30.

Further, the higher temperature fluid that has flowed in through the second inflow portion 307 of the fixed disc 30 flows through the variable communication path 405 of the movable disc 40 to flow out through its inner-periphery-side communication portion 405a into the outer-periphery-side communication portion 405b and then all (100%) of the higher temperature fluid flows from the outer-periphery-side communication portion 405b to flow out through the sub high temperature outflow port 309 of the fixed disc 30.

Similarly, the mixed fluid that has flowed in through the third inflow portion 310 of the fixed disc 30 flows through the variable communication path 406 of the movable disc 40 to flow out through its inner-periphery-side communication portion 406a into the outer-periphery-side communication portion 406b and then all (100%) of the mixed fluid flows from the outer-periphery-side communication portion 406b to flow out through the main mixture outflow port 311 of the fixed disc 30.

Further, for example, as illustrated in FIG. 12(b), the movable disc 40 is driven to rotate to and is stopped at such a position that the outer-periphery-side communication portion 404b of the variable communication path 404 for the low temperature fluid is opposed to both of the main low temperature outflow port 305 and the sub low temperature outflow port 306 of the fixed disc 30.

At this time, the movable disc 40 is stopped at such a position that the outer-periphery-side communication portion 405b of the variable communication path 405 for the high temperature fluid is opposed to both of the main high temperature outflow port 308 and the sub high temperature outflow port 309 of the fixed disc 30 and the outer-periphery-side communication portion 406b of the variable communication path 406 for the branched fluid is opposed to both of the main mixture outflow port 311 and the sub mixture outflow port 312 of the fixed disc 30.

Thus, the lower temperature fluid that has flowed in through the first inflow portion 304 of the fixed disc 30 flows out through the inner-periphery-side communication portion 404a to the outer-periphery-side communication portion 404b via the variable communication path 404 of the movable disc 40. Then, lower temperature fluids (50%/50% in the illustrated example) at a ratio corresponding to a ratio of opposed areas, flow from the outer-periphery-side communication portion 404b and then flow out through the main low temperature outflow port 305 and the sub low temperature outflow port 306 of the fixed disc 30.

Further, the higher temperature fluid that has flowed in through the second inflow portion 307 of the fixed disc 30 flows out through the inner-periphery-side communication portion 405a to the outer-periphery-side communication portion 405b via the variable communication path 405 of the movable disc 40. Then, higher temperature fluids (50%/50% in the illustrated example) at a ratio corresponding to a ratio of opposed areas, flow from the outer-periphery-side communication portion 405b and then flow out through the main high temperature outflow port 308 and the sub high temperature outflow port 309 of the fixed disc 30.

Similarly, the mixed fluid that has flowed in through the third inflow portion 310 of the fixed disc 30 flows out through the inner-periphery-side communication portion 406a to the outer-periphery-side communication portion 406b via the variable communication path 406 of the movable disc 40. Then, mixed fluids (50%/50% in the illustrated example) at a ratio corresponding to a ratio of opposed areas, flow from the outer-periphery-side communication portion 406b and then flow out through the main mixture outflow port 311 and the sub mixture outflow port 312 of the fixed disc 30.

As described above, the composite valve device 1 according to the first embodiment allows a single valve device to fulfill the functions corresponding to those of three three-way valves for, for example, distributing a fluid. Thus, although three three-way valves have been traditionally required, the composite valve device 1 allows a single valve device to fulfill the same functions. As a result, the valve device itself can be significantly reduced in size.

Further, the composite valve device 1 according to the first embodiment can linearly control the flow rates of three fluids, which are the lower temperature fluid, the higher temperature fluid, and the mixed fluid, from 0% to 100% or from 100% to 0% by simply driving one movable disc 40 to rotate. Thus, as compared to a case in which the flow rates of three fluids, which are the lower temperature fluid, the higher temperature fluid, and the mixed fluid, are controlled by using three three-way valves, mismatch in timing of controlling the flow rates of the fluids can be prevented.

Further, the composite valve device 1 according to the first embodiment can control the flow rates of the lower temperature fluid and the higher temperature fluid by using the combination of the fixed disc 30 and the movable disc 40, each having a flat sheet shape. Thus, even when the fluid adapted to about −100 °C is used as the lower temperature fluid, not only the lower temperature fluid but also the higher temperature fluid flows into and out from the fixed disc 30 and the movable disc 40. Accordingly, as compared to a case in which the lower temperature fluid at about −100 °C is controlled by a single three-way valve, exposure of the composite valve device 1 to an extremely low temperature of about −100 °C can be prevented or reduced. As a result, the lower temperature fluid at about −100 °C can be dealt with.

Further, the composite valve device 1 according to the first embodiment includes the combination of the fixed disc 30 and the movable disc 40, each having a flat sheet shape. Thus, its configuration is significantly simple, and hence there is little risk of entrapment of foreign matter. Thus, a strainer-less structure can be achieved.

### Example 1

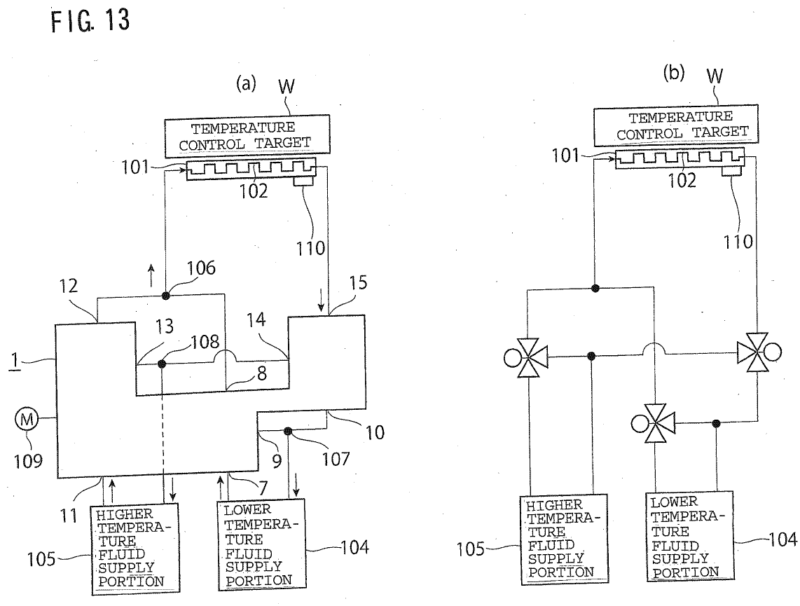

FIG. 13 are views for illustrating the concept of a constant-temperature maintaining device (chiller device) as one example of the temperature control device to which the composite valve device according to the first embodiment of the present invention is applied.

This chiller device 100 is used for, for example, a semiconductor manufacturing apparatus involving plasma etching and the like, and is configured to maintain a temperature of a semiconductor wafer or the like as one example of a temperature control target W, at a constant temperature. When the temperature control target W such as a semiconductor wafer undergoes plasma etching or the like, its temperature may rise along with the generation of plasma, electrical discharge, or the like. Further, a semiconductor wafer or the like as one example of the temperature control target W may be required to be maintained at two different required temperatures or the like while the temperatures are switched at short time intervals, in accordance with processing steps thereof.

The chiller device 100 includes a temperature control portion 101 formed of an electrostatic chuck (ESC) or the like formed in a table-like shape as one example of temperature control means. The temperature control portion 101 is arranged so as to be in contact with the temperature control target W. The temperature control portion 101 includes a flow passage 102 for temperature control therein, through which a fluid for temperature control including the lower temperature fluid and the higher temperature fluid at an adjusted mixture ratio is allowed to flow.

The composite valve device 1 according to the first embodiment is connected to the flow passage 102 for temperature control of the temperature control portion 101 through intermediation of an on-off valve (not shown) that allows and stops supply of the fluid for temperature control to the flow passage 102 for temperature control. A supply port of a lower temperature fluid supply portion 104 configured to supply the lower temperature fluid adjusted to a predetermined lower set temperature is connected to the first introduction port 7 of the composite valve device 1. Further, a supply port of a higher temperature fluid supply portion 105 configured to supply the higher temperature fluid adjusted to a predetermined higher set temperature is connected to the second introduction port 11 of the composite valve device 1. Further, a pipe for returning the mixed fluid that has flowed through the flow passage 102 for temperature control of the temperature control portion 101 is connected to the third introduction port 15 of the composite valve device 1.

Further, the main outlet port 8 for the lower temperature fluid of the composite valve device 1 is joined to the main outlet port 12 for the higher temperature fluid at a first mixing portion 106 outside the valve main body 2 as one example of the fixed disc 30 side. The first mixing portion 106 is connected to an inflow portion of the flow passage 102 for temperature control of the temperature control portion 101. Meanwhile, the sub outlet port 9 for the lower temperature fluid of the composite valve device 1 is joined to the main outlet port 10 for the mixed fluid at a second mixing portion 107 outside the valve main body 2 as one example of the fixed disc 30 side. The second mixing portion 107 is connected to a return side of the lower temperature fluid supply portion 104.

Further, the sub outlet port 13 for the higher temperature fluid of the composite valve device 1 is joined to the sub outlet port 14 for the mixed fluid at a third mixing portion 108 outside the valve main body 2 as one example of the fixed disc 30 side. The third mixing portion 108 is connected to a return side of the higher temperature fluid supply portion 105.

FIG. 13(b) is an equivalent circuit diagram for illustrating flow passages obtained when the composite valve device 1 according to the first embodiment is replaced by three three-way valves that fulfill the same functions.

The composite valve device 1 according to the first embodiment includes a drive motor 109 formed of a stepping motor or a servomotor, which is configured to drive the movable shaft 41 to rotate, in the actuator 4. Further, a temperature sensor 110 configured to detect a temperature of the temperature control portion 101 is provided to the temperature control portion 101. The temperature sensor 110 is connected to a control device (not shown). The control device controls the drive of the drive motor 109 of the composite valve device 1.

As illustrated in FIG. 13(a), the chiller device 100 detects a temperature of the temperature control target W with the temperature sensor 110, and controls rotation of the drive motor 109 of the composite valve device 1 with the control device based on the result of the detection of the temperature sensor 110 so that the temperature of the temperature control target W is controlled to a temperature equal to a predetermined set temperature.

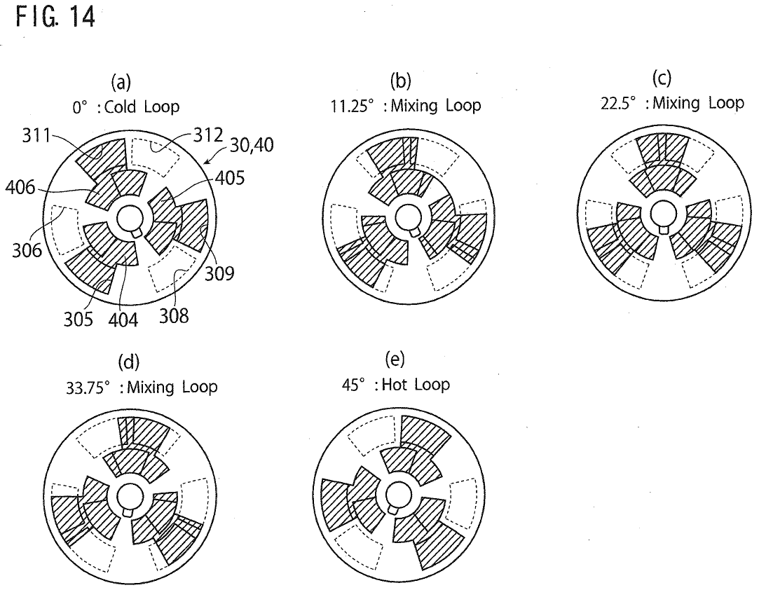

As illustrated in FIG. 14, the composite valve device 1 controls a mixture ratio between the lower temperature fluid supplied from the lower temperature fluid supply portion 104 and the higher temperature fluid supplied from the higher temperature fluid supply portion 105, and controls a distribution ratio at which the mixed fluid returned from the temperature control portion 101 is distributed to the lower temperature fluid supply portion 104 and the higher temperature fluid supply portion 105, by controlling the rotation of the drive motor 109, so that a temperature of the fluid for temperature control in which the lower temperature fluid and the higher temperature fluid are mixed, which is to be supplied to the flow passage 102 for temperature control of the temperature control portion 101, is controlled. The mixture ratio between the lower temperature fluid and the higher temperature fluid, and the distribution ratio at which the mixed fluid is distributed to the lower temperature fluid supply portion 104 and the higher temperature fluid supply portion 105 are set to have the same relationship. That is, when the mixture ratio between the lower temperature fluid and the higher temperature fluid is 8:2, the distribution ratio at which the mixed fluid is distributed to the lower temperature fluid supply portion 104 and the higher temperature fluid supply portion 105 is also set to 8:2.

At this time, the composite valve device 1 can control the mixture ratio between the lower temperature fluid and the higher temperature fluid with high accuracy in accordance with a rotation angle of the movable shaft 41 to thereby enable fine adjustment of the temperature of the fluid for temperature control. Thus, the chiller device 100 using the composite valve device 1 according to this embodiment can control the temperature of the temperature control target W, with which the temperature control portion 101 is in contact, to a desired temperature by allowing the fluid for temperature control adjusted to a predetermined temperature, for which the mixture ratio between the lower temperature fluid and the higher temperature fluid is controlled, to flow through the flow passage 102 for temperature control of the temperature control portion 101.

In the embodiment described above, description has been given of the fixed disc in which a plurality of inflow ports are arranged on the inner periphery side and at least two outflow ports corresponding to each of the inflow ports are arranged on the outer periphery side. However, the fixed disc may be configured such that a plurality of inflow ports are arranged on the outer periphery side and at least one outflow port corresponding thereto is arranged on the inner periphery side.

### Second Embodiment

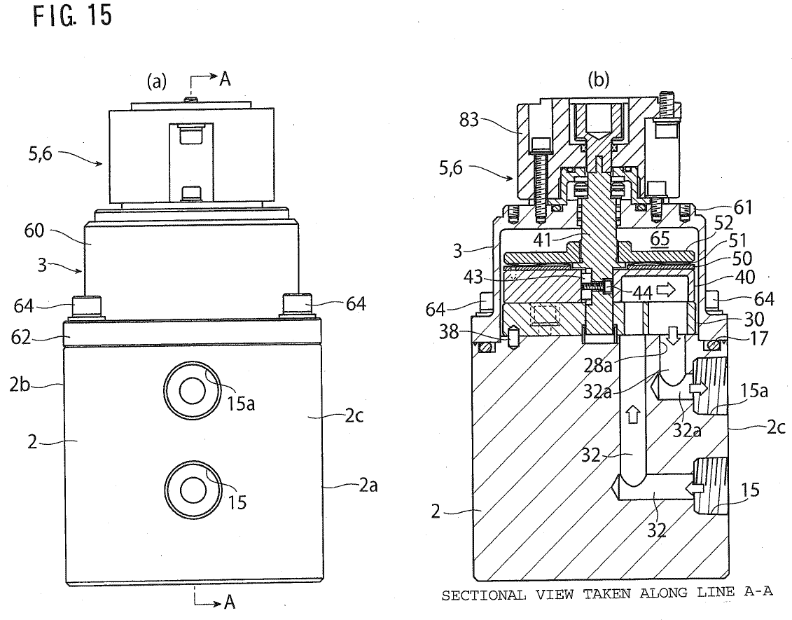

FIG. 15 is a configuration view for illustrating a composite valve device according to a second embodiment of the present invention.

A composite valve device 1 according to the second embodiment is configured to have, in addition to the functions of the composite valve device according to the first embodiment described above, a function to individually supply a lower temperature fluid to a temperature control portion 101, a function to individually supply a higher temperature fluid to the temperature control portion 101, and a function to individually supply a mixed fluid to the temperature control portion 101.

As illustrated in FIG. 15, the composite valve device 1 according to the second embodiment includes, as in the first embodiment, a fixed disc 30 and a movable disc 40.

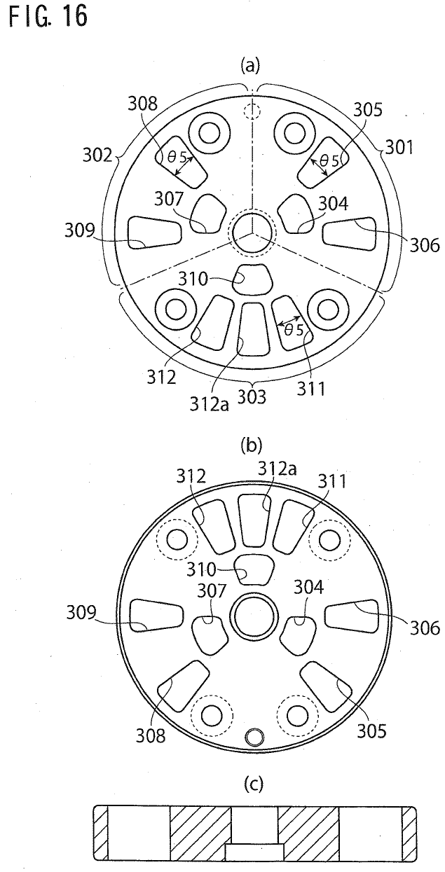

As illustrated in FIG. 16, the fixed disc 30 basically has, as in the first embodiment, a first valve region 301, a second valve region 302, and a third valve region 303 corresponding to three three-way valves. The three-way valve that forms the third valve region 303 of the fixed disc 30 is configured to fulfill functions as two three-way valves.

In the first valve region 301 of the fixed disc 30, as in the first embodiment, a first inflow port 304, a main low temperature outflow port 305, and a sub low temperature outflow port 306 are opened as a three-way valve for the lower temperature fluid. The first inflow port 304 as one example of a flow port allows inflow of the lower temperature fluid as the first fluid. The main low temperature outflow port 305 and the sub low temperature outflow port 306 are one example of branching outflow ports (branching/mixing flow ports), which are formed such that at least two (two in the illustrated example) thereof correspond to the first inflow port 304, and which allow the lower temperature fluid that has flowed in through the first inflow port 304 to be branched and flow out. However, the main low temperature outflow port 305 and the sub low temperature outflow port 306 are not arranged in proximity to each other in a circumferential direction unlike the main low temperature outflow port 305 and the sub low temperature outflow port 306 of the first embodiment, and are arranged spaced apart from each other in the circumferential direction. The main low temperature outflow port 305 and the sub low temperature outflow port 306 are each formed in a fan-like shape with a smaller central angle θ5 as compared to the central angle in the first embodiment.

Similarly, in the second valve region 302 of the fixed disc 30, a second inflow port 307, a main high temperature outflow port 308, and a sub high temperature outflow port 309 are opened as a three-way valve for the higher temperature fluid. The second inflow port 307 as one example of a flow port allows inflow of the higher temperature fluid as the second fluid. The main high temperature outflow port 308 and the sub high temperature outflow port 309 are one example of branching outflow ports (branching/mixing flow ports), which are formed such that at least two (two in the illustrated example) thereof correspond to the second inflow port 307, and which allow the higher temperature fluid that has flowed in through the second inflow port 307 to be branched and flow out. However, the main high temperature outflow port 308 and the sub high temperature outflow port 309 are not arranged in proximity to each other in a circumferential direction unlike the main high temperature outflow port 308 and the sub high temperature outflow port 309 of the first embodiment, and are arranged spaced apart from each other in the circumferential direction. The main high temperature outflow port 308 and the sub high temperature outflow port 309 are each formed in a fan-like shape with a smaller central angle θ5 as compared to the central angle in the first embodiment.

In addition, in the third valve region 303 of the fixed disc 30, a third inflow port 310, a main mixture outflow port 311, a sub mixture outflow port 312, and a circulating mixture outflow port 312a are opened as a three-way valve for the mixed fluid. The third inflow port 310 as one example of a flow port allows inflow of the mixed fluid as the third fluid. The main mixture outflow port 311, the sub mixture outflow port 312, and the circulating mixture outflow port 312a are one example of branching outflow ports (branching/mixing flow ports), which are formed such that at least two (three in the illustrated example) thereof correspond to the third inflow port 310, and which allow the mixed fluid that has flowed in through the third inflow port 310 to be branched and flow out. The circulating mixture outflow port 312a is arranged between the main mixture outflow port 311 and the sub mixture outflow port 312 so as to be adjacent thereto and spaced apart from each other by an equal distance. The main mixture outflow port 311 and the sub mixture outflow port 312 are each formed in a fan-like shape with the smaller central angle θ5 as compared to the main mixture outlet 311 and the sub mixture outflow port 312 in the first embodiment. Further, the main low temperature outflow port 305, the sub low temperature outflow port 306, the main high temperature outflow port 308, the sub high temperature outflow port 309, the main mixture outflow port 311, the sub mixture outflow port 312, and the circulating mixture outflow port 312a are formed in fan-like shapes all having the same central angle θ5.

In the valve main body 2, as illustrated in FIG. 15(b), a tenth opening portion 28a corresponding to the circulating mixture outflow port 312a is opened. The tenth opening portion 28a is connected to an additional circulating mixture outlet port 15a via a passage 32a. The circulating mixture outlet port 15a is opened in a center of an upper end portion of a back surface 2c of the valve main body 2.

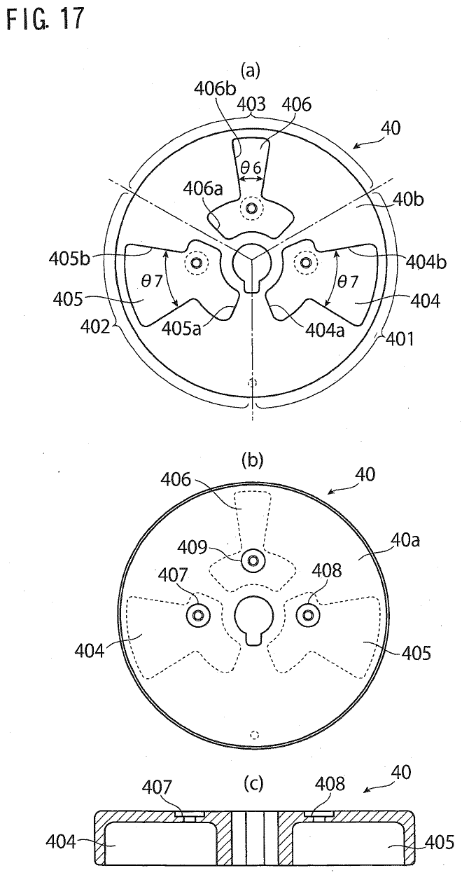

As illustrated in FIG. 17, similarly to the fixed disc 30, the movable disc 40 is segmented into a first valve region 401 to a third valve region 403 corresponding to three three-way valves. The movable disc 40 has three variable communication paths 404 to 406 in its lower end surface 40b. The variable communication paths 404 to 406 allow communication of the inflow ports of the fixed disc 30 and two or three branching outflow ports to each of the inflow ports so that the fluid is branched at a variable branching ratio.

The variable communication paths 404 to 406 of the movable disc 40 are different in shape from those of the first embodiment.

The third variable communication path 406 has an outer-periphery-side communication portion 406b with a central angle Smaller than that of the Outer-periphery-side communication portion of the first embodiment, but is basically configured in a similar manner. A central angle θ6 of the outer-periphery-side communication portion 406b is set equal to those of the main mixture outflow port 311, the sub mixture outflow port 312, and the like.

That is, the third variable communication path 406 is configured such that the outer-periphery-side communication portion 406b is brought into communication with each of the main mixture outflow port 311, the sub mixture outflow port 312, and the circulating mixture outflow port 312a or is selectively brought into communication with one of sets of two adjacent outflow ports, that is, a set of the main mixture outflow port 311 and the circulating mixture outflow port 312a or a set of the sub mixture outflow port 312 and the circulating mixture outflow port 312a.

Meanwhile, the first variable communication path 404 and the second variable communication path 405 are different from those of the first embodiment in a central angle of each of outer-periphery-side communication portions 404b and 405b and positional relationships with respect to inner-periphery-side communication portions 404a and 405a.

More specifically, the first variable communication path 404 and the second variable communication path 405 are different from those of the first embodiment in that a central angle θ7 of each of the outer-periphery-side communication portions 404b and 405b is set larger than those of the main low temperature outflow port 305 and the sub low temperature outflow port 306, and the main high temperature outflow port 308 and the sub high temperature outflow port 309 of the fixed disc 30.

Further, the first variable communication path 404 and the second variable communication path 405 are different from those of the first embodiment in positions of the outer-periphery-side communication portions 404b and 405b. The outer-periphery-side communication portions 404b and 405b are arranged not in a center between the main low temperature outflow port 305 and the sub low temperature outflow port 306 of the fixed disc 30 and in a center between the main high temperature outflow port 308 and the sub high temperature outflow port 309 of the fixed disc 30, in the circumferential direction, but are arranged at positions both displaced (shifted) toward the third variable communication path 406.

In the second embodiment, the shapes, the arrangement, and the number of main outflow ports and sub outflow ports of the fixed disc 30, and the shapes of the variable communication paths of the movable disc 40 are set different from those of the first embodiment. In this manner, functions of the composite valve device, which are different from those of the composite valve device of the first embodiment, are achieved.

Thus, the first variable communication path 404 and the second variable communication path 405 are configured such that, when one of the outer-periphery-side communication portions 404b and 405b of the first variable communication path 404 and the second variable communication path 405, for example, the outer-periphery-side communication portion 404b of the variable communication path 404 is in communication with only any one of the main low temperature outflow port 305 or the sub low temperature outflow port 306, the outer-periphery-side communication portion 405b of the second variable communication path 405, which is another one of the variable communication paths, can be in communication with both of the main high temperature outflow port 308 and the sub high temperature outflow port 309.

Similarly, the first variable communication path 404 and the second variable communication path 405 are configured such that, when the outer-periphery-side communication portion 405b of the variable communication path 405, which is another of the variable communication paths, is in communication with only any one of the main high temperature outflow port 308 or the sub high temperature outflow port 309, the outer-periphery-side communication portion 404b of the second variable communication path 404, which is one of the variable communication paths, can be in communication with both of the main low temperature outflow port 305 and the sub low temperature outflow port 306.

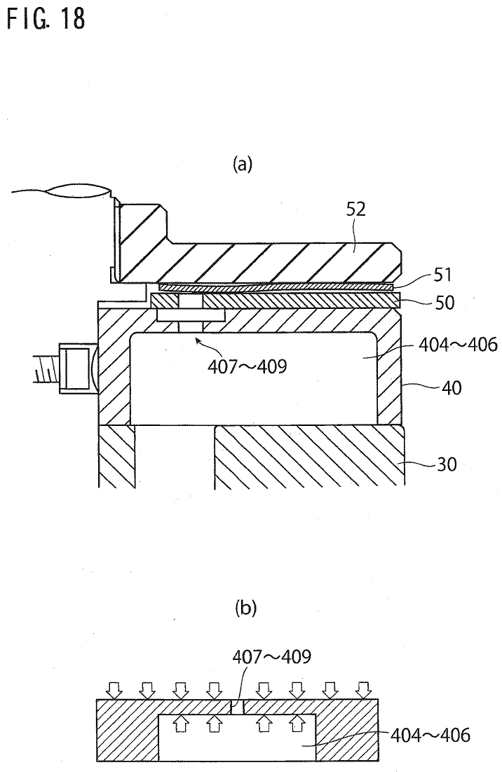

Further, in the second embodiment, an upper end surface 40a of the movable disc 40 is not completely closed. Pressure applying holes 407 to 409 that allow application of a pressure of the fluid onto the upper end surface 40a of the movable disc 40 so as to prevent the movable disc 40 from being separated upward are opened at positions on the upper end surface 40a, which correspond to three variable communication paths 404 to 406. As illustrated in FIG. 18, the pressure applying holes 407 to 409 allow the application of the pressure of the fluid onto the upper end surface 40a of the movable disc 40.

### Operation of Composite Valve Device

In the composite valve device 1 according to the second embodiment, flow rates of the lower temperature fluid, the higher temperature fluid, and the mixed fluid are controlled in the following manner.

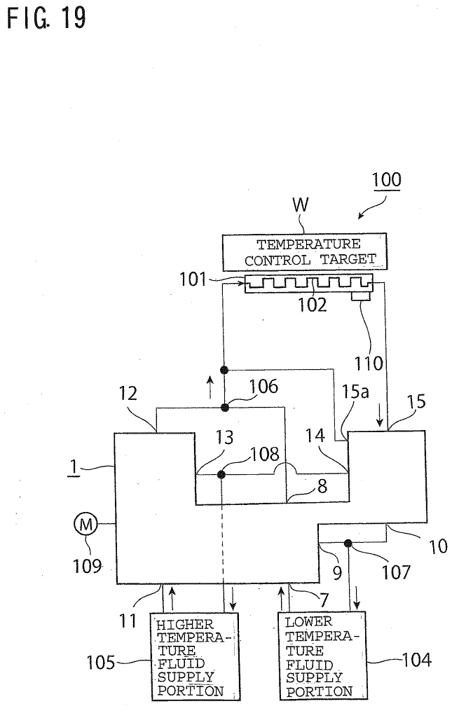

To the valve main body 2 of the composite valve device 1, as illustrated in FIG. 15, the lower temperature fluid adjusted to a predetermined lower-temperature-side set temperature, the higher temperature fluid adjusted to a predetermined higher-temperature-side set temperature, and the mixed fluid in which the lower temperature fluid and the higher temperature fluid are mixed are supplied through pipes (not shown) via the first introduction port 7, the second introduction port 11, and the third introduction port 15, respectively. As illustrated in FIG. 19, the circulating mixture outlet port 15a of the valve main body 2 of the composite valve device 1 is joined to a downstream side of a first mixture portion 106.

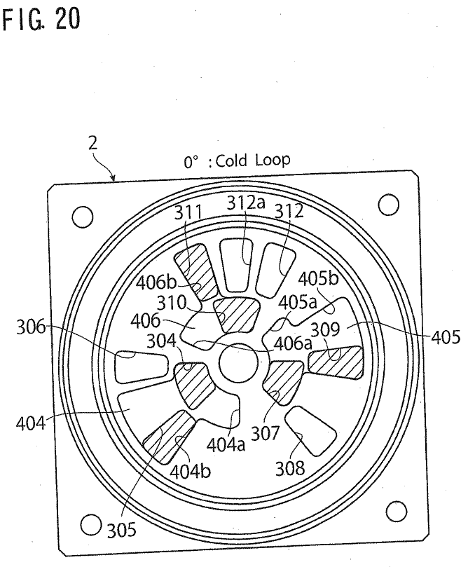

Now, as illustrated in FIG. 20, it is assumed that the composite valve device 1 is stopped at such a position that a rotation angle of the movable shaft 41 is 0°, which serves as a reference, the outer-periphery-side communication portion 404b of the variable communication path 404 of the movable disc 40 is opposed to only the main low temperature outflow port 305 of the fixed disc 30, the outer-periphery-side communication portion 405b of the variable communication path 405 of the movable disc 40 is similarly opposed to only the sub high temperature outflow port 309 of the fixed disc 30, and the outer-periphery-side communication portion 406b of the variable communication path 406 of the movable disc 40 is opposed to only the main mixture outflow port 311 of the fixed disc 30.

Then, in the composite valve device 1, as illustrated in FIG. 19, only the lower temperature fluid supply portion 104 is connected to the flow passage 102 for temperature control of the temperature control portion 101, and the lower temperature fluid at a predetermined temperature supplied from the lower temperature fluid supply portion 104 flows into the flow passage 102 for temperature control of the temperature control portion 101.

The lower temperature fluid as the mixed fluid that has flowed into the flow passage 102 for temperature control of the temperature control portion 101 is returned to the lower temperature fluid supply portion 104.

Meanwhile, in the composite valve device 1, the outer-periphery-side communication portion 405b of the variable communication path 405 of the movable disc 40 is opposed to only the sub high temperature outflow port 309 of the fixed disc 30. The higher temperature fluid that has flowed into the fixed disc 30 from the variable communication path 405 of the movable disc 40 flows out through the sub high temperature outflow port 309 of the fixed disc 30, and is returned to the higher temperature fluid supply portion 105 without being mixed with the lower temperature fluid supplied from the lower temperature fluid supply portion 104.

Further, in the composite valve device 1, the outer-periphery-side communication portion 406b of the variable communication path 406 of the movable disc 40 is opposed to only the main mixture outflow port 311 of the fixed disc 30. The lower temperature fluid as the mixed fluid that has flowed into the fixed disc 30 from the variable communication path 406 of the movable disc 40 flows out through the main mixture outflow port 311 of the fixed disc 30, and is returned directly to the lower temperature fluid supply portion 104.

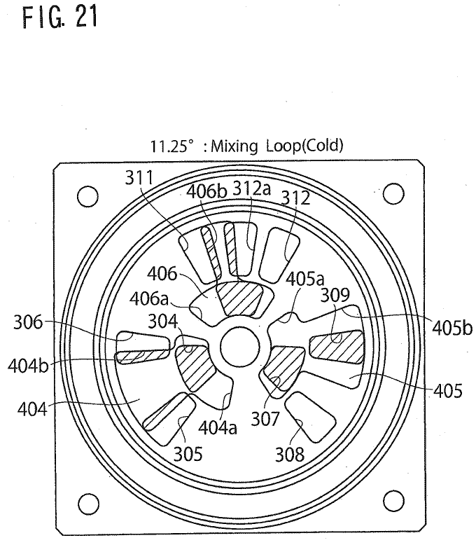

Further, as illustrated in FIG. 21, it is assumed that the movable disc 40 is rotated by a required angle (11.25°) in a clockwise direction and the composite valve device 1 is stopped at such a position that the outer-periphery-side communication portion 404b of the variable communication path 404 of the movable disc 40 is opposed to both of the main low temperature outflow port 305 and the sub low temperature outflow port 306 of the fixed disc 30, the outer-periphery-side communication portion 405b of the variable communication path 405 of the movable disc 40 is similarly opposed to only the sub high temperature outflow port 309 of the fixed disc 30, and the outer-periphery-side communication portion 406b of the variable communication path 406 of the movable disc 40 is opposed to both of the main mixture outflow port 311 and the circulating mixture outflow port 312a of the fixed disc 30.

Then, in the composite valve device 1, the lower temperature fluid supply portion 104 and the circulating mixture outflow port 312a are connected to the flow passage 102 for temperature control of the temperature control portion 101, and part of the lower temperature fluid at a predetermined temperature supplied from the lower temperature fluid supply portion 104 flows into the flow passage 102 for temperature control of the temperature control portion 101 while a flow rate thereof is being regulated.

Part of the lower temperature fluid as the mixed fluid that has flowed into the flow passage 102 for temperature control of the temperature control portion 101 is returned to the lower temperature fluid supply portion 104.

At the same time, part of the lower temperature fluid as the mixed fluid that has flowed into the flow passage 102 for temperature control of the temperature control portion 101 is supplied directly to the flow passage 102 for temperature control. Thus, part of the lower temperature fluid at a predetermined temperature supplied from the lower temperature fluid supply portion 104 and a remaining part of the lower temperature fluid as the mixed fluid, which has a temperature that has changed (risen) after passage of the lower temperature fluid through the flow passage 102 for temperature control, are supplied in a mixed state to the flow passage 102 for temperature control.

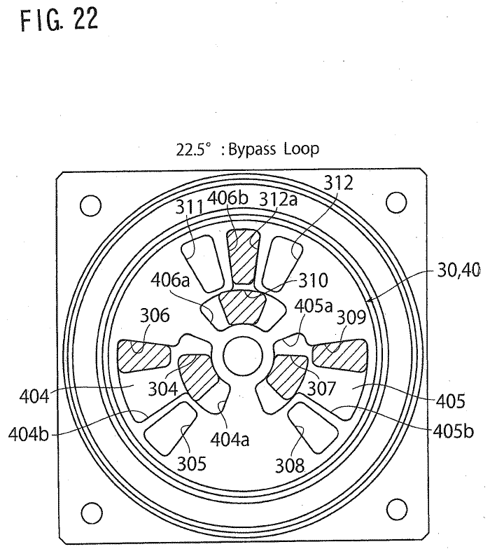

Further, as illustrated in FIG. 22, it is assumed that the movable disc 40 is rotated by a required angle (22.5°) in the clockwise direction and the composite valve device 1 is Stopped at such a position that the outer-periphery-side communication portion 404b of the variable communication path 404 of the movable disc 40 is opposed to only the sub low temperature outflow port 306 of the fixed disc 30, the outer-periphery-side communication portion 405b of the variable communication path 405 of the movable disc 40 is similarly opposed to only the sub high temperature outflow port 309 of the fixed disc 30, and the outer-periphery-side communication portion 406b of the variable communication path 406 of the movable disc 40 is opposed to only the circulating mixture outflow port 312a of the fixed disc 30.

Then, in the composite valve device 1, the flow passage of the lower temperature fluid supply portion 104, the flow passage of the higher temperature fluid supply portion 105, and the flow passage 102 for temperature control of the temperature control portion 101 are brought into a state of being disconnected from each other.

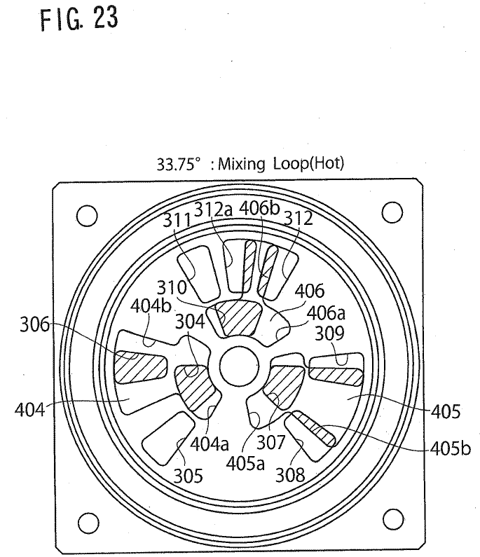

Meanwhile, as illustrated in FIG. 23, it is assumed that the movable disc 40 is rotated by a required angle (33.75°) in a clockwise direction and the composite valve device 1 is stopped at such a position that the outer-periphery-side communication portion 404b of the variable communication path 404 of the movable disc 40 is opposed to only the sub low temperature outflow port 306 of the fixed disc 30, the outer-periphery-side communication portion 405b of the variable communication path 405 of the movable disc 40 is similarly opposed to both of the main high temperature outflow port 308 and the sub high temperature outflow port 309 of the fixed disc 30, and the outer-periphery-side communication portion 406b of the variable communication path 406 of the movable disc 40 is opposed to both of the sub mixture outflow port 312 and the circulating mixture outflow port 312a of the fixed disc 30.

Then, in the composite valve device 1, the higher temperature fluid supply portion 105 and the circulating mixture outflow port 312a are connected to the flow passage 102 for temperature control of the temperature control portion 101, and part of the higher temperature fluid at a predetermined temperature supplied from the higher temperature fluid supply portion 105 flows into the flow passage 102 for temperature control of the temperature control portion 101 while a flow rate thereof is being regulated.

Part of the higher temperature fluid as the mixed fluid that has flowed into the flow passage 102 for temperature control of the temperature control portion 101 is returned to the higher temperature fluid supply portion 105.

At the same time, part of the higher temperature fluid as the mixed fluid that has flowed into the flow passage 102 for temperature control of the temperature control portion 101 is supplied directly to the flow passage 102 for temperature control. Thus, part of the higher temperature fluid at a predetermined temperature supplied from the higher temperature fluid supply portion 105 and a remaining part of the higher temperature fluid as the mixed fluid, which has a temperature that has changed (dropped or risen) after passage of the higher temperature fluid through the flow passage 102 for temperature control, are supplied in a mixed state to the flow passage 102 for temperature control.

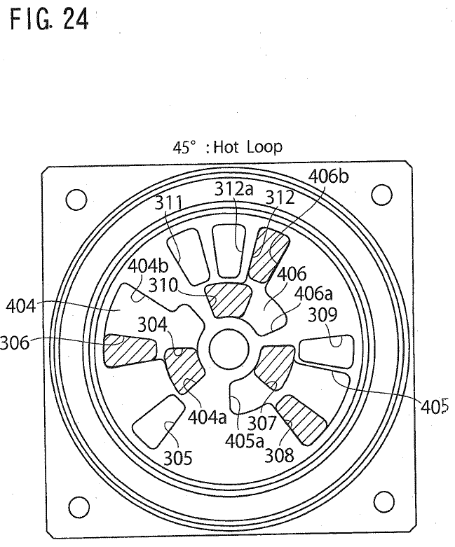

Finally, as illustrated in FIG. 24, it is assumed that the movable disc 40 is rotated by a required angle (45°) in the clockwise direction and the composite valve device 1 is stopped at such a position that the outer-periphery-side communication portion 404b of the variable communication path 404 of the movable disc 40 is opposed to only the sub low temperature outflow port 306 of the fixed disc 30, the outer-periphery-side communication portion 405b of the variable communication path 405 of the movable disc 40 is similarly opposed to only the main high temperature outflow port 308 of the fixed disc 30, and the outer-periphery-side communication portion 406b of the variable communication path 406 of the movable disc 40 is opposed to only the sub mixture outflow port 312 of the fixed disc 30.

Then, in the composite valve device 1, only the higher temperature fluid supply portion 105 is connected to the flow passage 102 for temperature control of the temperature control portion 101, allowing the higher temperature fluid at a predetermined temperature supplied from the higher temperature fluid supply portion 105 to flow into the flow passage 102 for temperature control of the temperature control portion 101.

The higher temperature fluid as the mixed fluid that has flowed into the flow passage 102 for temperature control of the temperature control portion 101 is returned to the higher temperature fluid supply portion 105.

### Experimental Example

The inventor of the present invention experimentally produced the composite valve device 1 including the fixed disc 30 and the movable disc 40 as illustrated in FIG. 16 and FIG. 17, and conducted an experiment for checking how flow coefficient Cv values of the lower temperature fluid, the higher temperature fluid, and the mixed fluid changed in accordance with the position of the movable disc 40, which was changed along with the rotation of the movable shaft 41. As the lower temperature fluid, Novec 7200 (manufactured by 3M Company: trademark) at a temperature of −60 °C was used. As the higher temperature fluid, Novec 7200 at a temperature of 50 °C was used.

The flow coefficient Cv values of the lower temperature fluid, the higher temperature fluid, and the fluid for temperature control, in which the lower temperature fluid and the higher temperature fluid were mixed, were measured with a flow rate sensor with high detection accuracy, which was moved to each of the introduction ports and the outlet ports of the valve main body 2 when the rotation angle of the movable shaft 41 of the composite valve device 1 was changed.

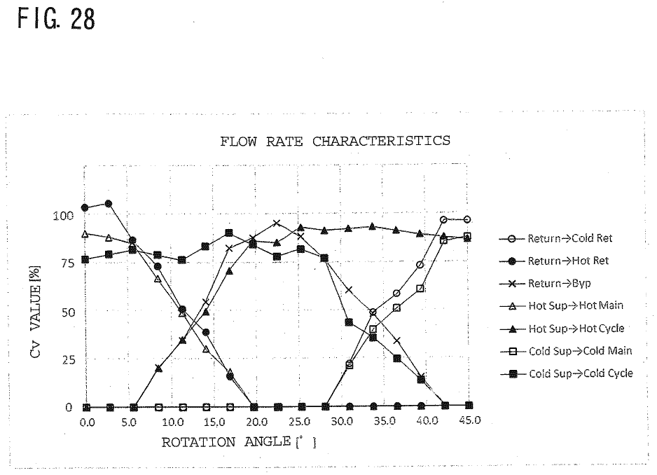

FIG. 28 is a graph for showing the results of the experimental example described above. In FIG. 28, the horizontal axis represents the rotation angle of the movable shaft 41, and the vertical axis represents the flow coefficient Cv value of each of the fluids.

In FIG. 28, the line “Cold Sup→Cold Main” represents the flow coefficient Cv value in a case in which the lower temperature fluid flowed in through the first introduction port 7 of the valve main body 2 and flowed out through the main outlet port 8 for the lower temperature fluid, the line “Cold Sup→Cold Cycle” represents the flow coefficient Cv value in a case in which the lower temperature fluid flowed in through the first introduction port 7 and flowed out through the sub outlet port 9 for the lower temperature fluid, the line “Hot Sup→Hot Main” represents the flow coefficient Cv value in a case in which the higher temperature fluid flowed in through the second introduction port 11 and flowed out through the main outlet port 12 for the higher temperature fluid, the line “Hot Sup→Hot Cycle” represents the flow coefficient Cv value in a case in which the higher temperature fluid flowed in through the second introduction port 11 and flowed out through the sub outlet port 13 for the higher temperature fluid, the line “Return→Cold Ret” represents the flow coefficient Cv value in a case in which the mixed fluid flowed in through the third introduction port 15 and flowed out through the main outlet port 10 for the mixed fluid, the line “Return→Hot Ret” represents the flow coefficient Cv value in a case in which the mixed fluid flowed in through the third introduction port 15 and flowed out through the sub outlet port 14 for the mixed fluid, and the line “Return→Byp” represents the flow coefficient Cv value in a case in which the mixed fluid flowed in through the third introduction port 15 and flowed out through the circulating mixture outlet port 15a.

As a result, as is apparent from the graph of FIG. 28, it was found that the Cv values, each indicating the flow coefficient, increased or decreased substantially linearly for the higher temperature fluid and the mixed fluid, among the lower temperature fluid, the higher temperature fluid, and the mixed fluid, in accordance with the rotation angle of the movable shaft 41 to thereby accurately control the flow rates of the lower temperature fluid, the higher temperature fluid, and the mixed fluid.

Other configurations and effects are similar to those of the first embodiment, and thus description thereof is omitted.

### Third Embodiment

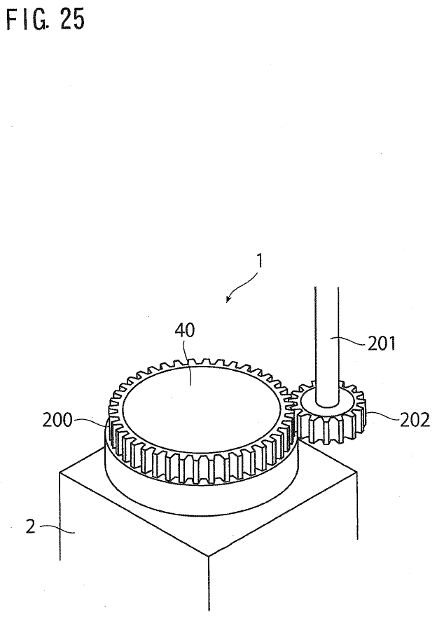

FIG. 25 is a configuration view for illustrating a composite valve device according to a third embodiment of the present invention.

As illustrated in FIG. 25, a composite valve device 1 according to the third embodiment is configured so that the movable disc 40 is driven to rotate not through intermediation of the movable shaft 41 but is driven to rotate by a drive gear 202, which is driven through intermediation of a drive shaft 201, through intermediation of a gear portion 200 provided integrally with or separately from an outer periphery of the movable disc 40.

As described above, in the case of the composite valve device 1 according to the third embodiment, an actuator 4 can be arranged on the side of the valve main body 2, thus enabling a reduction in overall height of the composite valve device 1.

Other configurations and effects are similar to those of the first embodiment, and thus description thereof is omitted.

### Fourth Embodiment

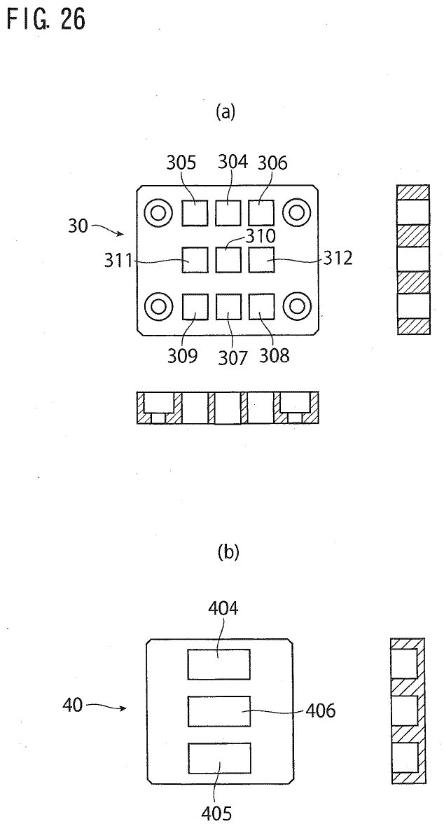

FIG. 26 are configuration views for illustrating a composite valve device according to a fourth embodiment of the present invention.

As illustrated in FIG. 26, in a composite valve device 1 according to the fourth embodiment, a fixed disc 30 as one example of a fixed-side valve body and a movable disc 40 as one example of a movable valve body are each formed not in a flat sheet shape being circular in plan view, but in a flat sheet shape being rectangular in plan view.

Further, the composite valve device 1 according to the fourth embodiment is configured so that the movable disc 40 is not moved so as to be rotated with respect to the fixed disc 30, but is linearly slid to be moved with respect to the fixed disc 30.

As illustrated in FIG. 26, in the fixed disc 30, a first inflow port 304, a second inflow port 307, and a third inflow port 310; and a main low temperature outflow port 305 and a sub low temperature outflow port 306, a main high temperature outflow port 308 and a sub high temperature outflow port 309, and a main mixture outflow port 311 and a sub mixture outflow port 312, which correspond to the inflow ports 304, 307, and 310, respectively, are opened. The inflow ports 304, 307, and 310 are arranged so as to be positioned in a middle.

Meanwhile, in the movable disc 40, a first variable communication path 404, a second variable communication path 405, and a third variable communication path 406 are formed.

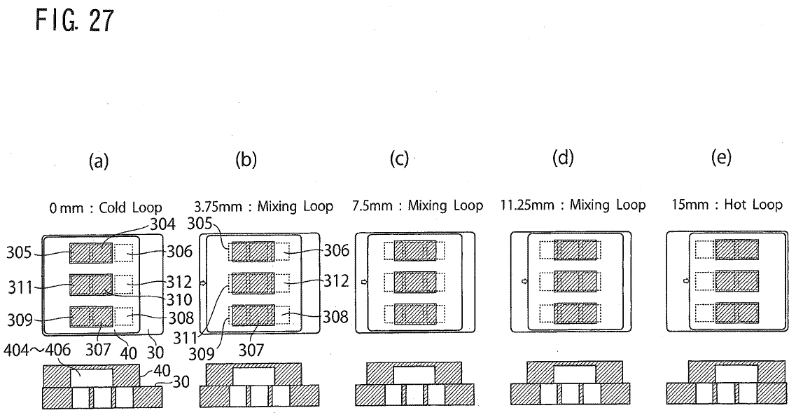

As illustrated in FIG. 27, the movable disc 40 is configured, when linearly slid with respect to the fixed disc 30, to selectively or simultaneously bring the first to third inflow ports of the fixed disc 30 into communication with the main low temperature outflow port 305 and the sub low temperature outflow port 306, the main high temperature outflow port 308 and the sub high temperature outflow port 309, and the main mixture outflow port 311 and the sub mixture outflow port 312, which correspond thereto.

In the composite valve device 1 according to the fourth embodiment, the movable disc 40 is only required to be linearly moved. Thus, an actuator 4 and an overall device can be reduced in size.

Other configurations and effects are similar to those of the first embodiment, and thus description thereof is omitted.

### Fifth Embodiment

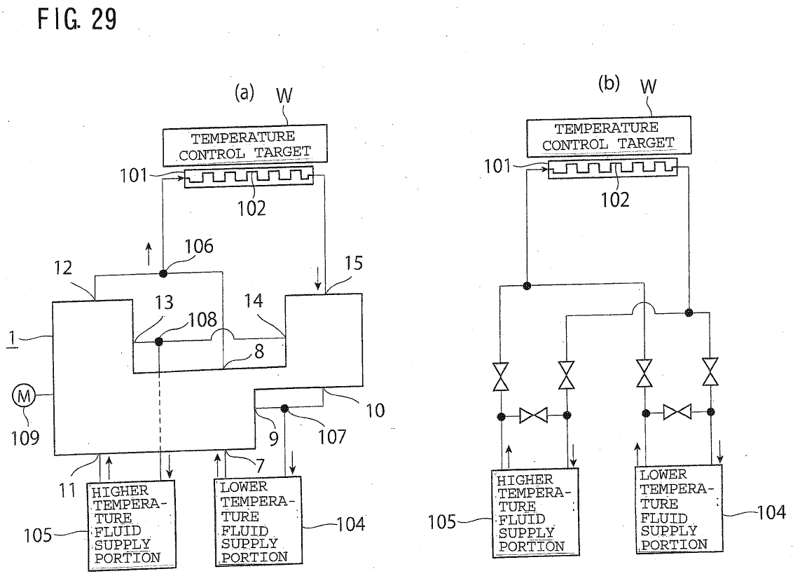

FIG. 29 are configuration diagrams for illustrating a temperature control device according to a fifth embodiment of the present invention, which uses the composite valve device.

A temperature control device 100 according to the fifth embodiment uses the composite valve device 1 according to the first embodiment or the second embodiment as a composite valve device 1 without any change.

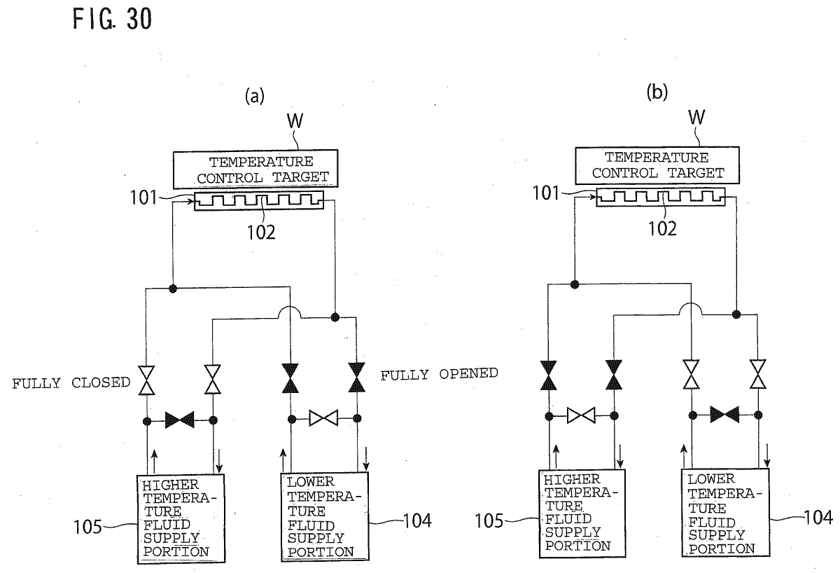

As illustrated in equivalent circuits of FIG. 30, the temperature control device 100 is configured to supply the lower temperature fluid supplied from a lower temperature fluid supply portion 104 and the higher temperature fluid supplied from a higher temperature fluid supply portion 105 to a flow passage 102 for temperature control of a temperature control portion 101 while switching the two fluids, and this configuration is also associated with a way of using the composite valve device 1 according to the first embodiment or the second embodiment.

The composite valve device 1 is switched to a state illustrated in FIG. 14(a) or FIG. 20. As illustrated in FIG. 29(a) and FIG. 30(a), the lower temperature fluid supplied from the lower temperature fluid supply portion 104 is introduced into a first introduction port 7 of a valve main body 2, flows into a first inflow port 304 of a fixed disc 30 via a passage and a first opening portion 20, and all of the lower temperature fluid flows out through a variable communication path 404 of a movable disc 40 to a main low temperature outflow port 305.

In the composite valve device 1, the lower temperature fluid that has flowed out to the main low temperature outflow port 305 is discharged through a passage and a main outlet port 8 via a fourth opening portion 23 of the valve main body 2, and is supplied from a first mixing portion 106 to the flow passage 102 for temperature control of the temperature control portion 101.

The lower temperature fluid that has flowed through the flow passage 102 for temperature control of the temperature control portion 101 is introduced through a third introduction port 15 of the valve main body 2, flows into a third inflow port 310 of the fixed disc 30 via a passage and a third opening portion 22, and all of the lower temperature fluid flows out through a variable communication path 406 of the movable disc 40 to a main mixture outflow port 311.

In the composite valve device 1, the lower temperature fluid that has flowed out through the main mixture outflow port 311 is discharged through a passage and a main outlet port 10 via an eighth opening portion 27 of the valve main body 2, and is returned from a second mixing portion 107 to the lower temperature fluid supply portion 104.

Further, in the composite valve device 1, the higher temperature fluid supplied from the higher temperature fluid Supply portion 105 is introduced through a second introduction port 11 of the valve main body 2, flows into a second inflow port 307 of the fixed disc 30 via a passage and a second opening portion 21, and all of the higher temperature fluid flows out through a variable communication path 405 of the movable disc 40 to a sub low temperature outflow port 309. Then, the higher temperature fluid that has flowed out to the sub low temperature outflow port 309 is discharged through a sub outlet port 13 of the valve main body 2 via a seventh opening portion 26 and a passage, and is returned to the higher temperature fluid supply portion 105 via the second mixing portion 107.

After that, in the composite valve device 1, the movable disc 40 is rotated by 45 degrees over a predetermined short time period (from about six seconds to about eight seconds).

Then, the composite valve device 1 is switched to a state illustrated in FIG. 14(e) or FIG. 24. As illustrated in FIG. 29(a) and FIG. 30(b), the higher temperature fluid supplied from the higher temperature fluid supply portion 105 is introduced into the second introduction port 11 of the valve main body 2, flows into a second inflow port 307 of the fixed disc 30 via a passage and the second opening portion 21, and all of the higher temperature fluid flows out through the variable communication path 405 of a movable disc 40 to a main high temperature outflow port 308.

In the composite valve device 1, the higher temperature fluid that has flowed out to the main high temperature outflow port 308 is discharged through a passage and a main outlet port 12 via a sixth opening portion 25 of the valve main body 2, and is supplied from the first mixing portion 106 to the flow passage 102 for temperature control of the temperature control portion 101.

The higher temperature fluid that has flowed through the flow passage 102 for temperature control of the temperature control portion 101 is introduced through the third introduction port 15 of the valve main body 2, flows into the third inflow port 310 of the fixed disc 30 via a passage and the third opening portion 22, and all of the higher temperature fluid flows out through the variable communication path 406 of the movable disc 40 to a main mixture outflow port 312.

In the composite valve device 1, the higher temperature fluid that has flowed out through the main mixture outflow port 312 is discharged through a passage and a main outlet port 14 via a ninth opening portion 28 of the valve main body 2, and is returned from a third mixing portion 108 to the higher temperature fluid supply portion 105.

As described above, the temperature control device 100 according to the fifth embodiment can supply the lower temperature fluid or the higher temperature fluid to the flow passage 102 for temperature control of the temperature control portion 101 by switching between the two fluids.

In the meantime, when the temperature control device 100 is switched from a state in which only the lower temperature fluid is supplied from the lower temperature fluid supply portion 104 to the flow passage 102 for temperature control of the temperature control portion 101 to a state in which only the higher temperature fluid is supplied from the higher temperature fluid supply portion 105, there is a state in which a fluid in which the lower temperature fluid and the higher temperature fluid are mixed is supplied therebetween.

Other configurations and effects are similar to those of the first embodiment or the second embodiment, and thus description thereof is omitted.

In the embodiments, description has been given of the case of the composite valve device that branches the fluids flowing in through the plurality of inflow ports. However, it is apparent that the composite valve device is not limited to the case of branching the fluids flowing in through the plurality of inflow ports, but may also be configured as a composite valve device that mixes the fluids at a desired mixture ratio by reversing directions of flow of the fluids.

More specifically, the introduction ports and the outlet ports are replaced by outlet ports and introduction ports, respectively; the inflow ports and the outflow ports are replaced by outflow ports and inflow ports, respectively; branching is replaced by mixing; and the main low temperature outflow ports, the sub low temperature outflow ports, and the like as one example of the branching outflow ports are replaced by main low temperature inflow ports and sub low temperature inflow ports. However, the variable communication paths remain as variable communication paths without being replaced.

### Reference Signs List

1 . . . composite valve device
2 . . . valve main body
3 . . . valve portion
4 . . . actuator
5 . . . sealing portion
6 . . . coupling portion
30 . . . fixed disc
304 . . . first inflow port
307 . . . second inflow port
310 . . . third inflow port
305, 306, 308, 309, 311, 312 . . . outflow port
40 . . . movable disc
404, 405, 406 . . . variable communication path
100 . . . chiller device

1. A composite valve device, comprising:
a fixed-side valve body having:
a plurality of flow ports being independent of each other; and
branching/mixing flow ports, which are formed such that at least two branching/mixing flow ports correspond to each of the flow ports, the branching/mixing flow ports each allowing a fluid flowing through each of the flow ports to be branched or mixed and flow; and
a movable valve body movably arranged in close contact with the fixed-side valve body, the movable valve body having a plurality of variable communication paths, each allowing communication of each of the flow ports and the at least two branching/mixing flow ports corresponding to the flow port while the fluid is branched or mixed at a variable branching/mixture ratio,
wherein the composite valve device is configured to function simultaneously as a plurality of valve devices.

2. The composite valve device according to claim 1,
wherein the fixed-side valve body is formed of a fixed disc having a circular shape in plan view,
wherein the plurality of flow ports are arranged on an inner periphery side in a circumferential direction on the fixed disc, and
wherein the at least two branching/mixing flow ports formed corresponding to each of the flow ports are arranged on an outer periphery side of the corresponding one of the flow ports of the fixed disc in a radial direction.

3. The composite valve device according to claim 2, wherein, when the number of flow ports is represented by N, the plurality of flow ports are arranged at positions obtained by equally dividing the fixed disc by N in the circumferential direction of the fixed disc.

4. The composite valve device according to claim 2, wherein the branching/mixing flow ports, which are formed such that at least two branching/mixing flow ports correspond to each of the flow ports, are arranged adjacent to each other in the circumferential direction of the fixed disc.

5. The composite valve device according to claim 2, wherein the branching/mixing flow ports, which are formed such that at least two branching/mixing flow ports correspond to each of the flow ports, are arranged spaced apart from each other in the circumferential direction of the fixed disc.

6. The composite valve device according to claim 1, wherein the movable valve body is formed of a movable disc having a circular shape in plan view, which is rotatably arranged in close contact with the fixed-side valve body, and wherein the plurality of variable communication paths are arranged spaced apart from each other in a circumferential direction of the movable disc.

7. The composite valve device according to claim 6, wherein each of the variable communication paths is formed in a groove shape in a radial direction of the movable disc, the groove shape being opened only on the fixed-side valve body side.

8. The composite valve device according to claim 1, wherein each of the variable communication paths has an end portion on a side corresponding to the flow ports and an end portion on a side corresponding to the branching/mixing flow ports of the fixed-side valve body, the end portions being formed in shapes corresponding to an opening shape of each of the flow ports and an opening shape of each of the branching/mixing flow ports, respectively.

9. The composite valve device according to claim 8, wherein the opening shape of each of the flow ports and the opening shape of each of the branching/mixing flow ports are each a fan-like shape or a circular shape.

10. The composite valve device according to claim 9, wherein one of the end portions of each of the plurality of variable communication paths is constantly in communication with a corresponding one of the flow ports even when the movable valve body is moved.

11. The composite valve device according to claim 1,
wherein each of the variable communication paths is, at a first position, in communication with the each flow port and one of the at least two branching/mixing flow ports of the fixed-side valve body,
at a second position, in communication with the each flow port and both of the at least two branching/mixing flow ports of the fixed-side valve body, and
at a third position, in communication with the each flow port and another one of the at least two branching/mixing flow ports.

12. The composite valve device according to claim 11, wherein, at the first position, one of the at least two branching/mixing flow ports formed corresponding to each of the plurality of flow ports, with which one of two of the plurality of variable communication paths is in communication, is different from one of the at least two branching/mixing flow ports, with which another one of the two variable communication paths is in communication.

13. The composite valve device according to claim 1, wherein the plurality of flow ports comprise three flow ports through which a higher temperature fluid being the same fluid at a relatively high temperature, a lower temperature fluid being the same fluid at a relatively low temperature, and a mixed fluid in which the higher temperature fluid and the lower temperature fluid are mixed are allowed to flow, respectively.

14. The composite valve device according to claim 1, wherein, among the plurality of flow ports and the branching/mixing flow ports of the fixed valve body, which are formed such that at least two branching/mixing flow ports correspond to each of the flow ports, a specific one of the flow ports and specific ones of the branching/mixing flow ports are connected in advance on the fixed valve body side.

15. The composite valve device according to claim 14, wherein one of the specific branching/mixing flow ports is a main branching/mixing flow port, through which the higher temperature fluid is allowed to mainly flow, and one of the specific branching/mixing flow ports is a main branching/mixing flow port, through which the lower temperature fluid is allowed to mainly flow.

16. The composite valve device according to claim 14, wherein one of the specific branching/mixing flow ports is a sub branching/mixing flow port, through which the higher temperature fluid is allowed to be branched and flow, and one of the specific branching/mixing flow ports is a sub branching/mixing flow port, through which the mixed fluid is allowed to be branched into the higher temperature fluid and flow.

17. The composite valve device according to claim 14, wherein one of the specific branching/mixing flow ports is a sub branching/mixing flow port, through which the lower temperature fluid is allowed to be branched and flow, and one of the specific branching/mixing flow ports is a sub branching/mixing flow port, through which the mixed fluid is allowed to be branched into the lower temperature fluid and flow.

18. The composite valve device according to claim 13, wherein the plurality of flow ports and the branching/mixing flow ports, which are formed such that at least two branching/mixing flow ports correspond to each of the flow ports, comprise:
a main higher-temperature-side branching/mixing flow port and a sub higher-temperature-side branching/mixing flow port, through which the higher temperature fluid is allowed to be branched and flow;
a main lower-temperature-side branching outflow port and a sub lower-temperature-side branching outflow port, through which the lower temperature fluid is allowed to be branched and flow; and
a higher-temperature-side branching/mixing flow port and a lower-temperature-side branching/mixing flow port, through which the mixed fluid is allowed to be branched and flow, and a supply-side branching/mixing flow port, which allows the mixed fluid to be branched to a supply side of the mixed fluid.

19. The composite valve device according to claim 18, wherein the higher-temperature-side main branching/mixing flow port, the lower-temperature-side main branching/mixing flow port, and the supply-side branching/mixing flow port are connected in advance to each other on the fixed valve body side.

20. The composite valve device according to claim 18, wherein the higher-temperature-side sub branching/mixing flow port, the higher-temperature-side branching/mixing flow port are connected in advance to each other on the fixed valve body side.

21. The composite valve device according to claim 18, wherein the higher-temperature-side sub branching/mixing flow port, the lower-temperature-side sub branching/mixing flow port, and the supply-side branching/mixing flow port are connected in advance to each other on the fixed valve body side.

22. The composite valve device according to claim 1, wherein each of the fixed-side valve body and the movable main body is made of a ceramic.

23. The composite valve device according to claim 22, wherein the plurality of flow ports and the plurality of branching/mixing flow ports formed in the fixed-side valve body, and the plurality of variable communication paths formed in the movable valve body each have corner portions each formed in a curved shape in plan view.

24. A temperature control device, comprising:
temperature control target having a flow passage for temperature control, through which a fluid for temperature control including a lower temperature fluid and a higher temperature fluid, which are mixed at an adjusted mixture ratio, is allowed to flow;
first supply portion for supplying the lower temperature fluid adjusted to a predetermined lower-temperature-side first temperature;
second supply portion for supplying the higher temperature fluid adjusted to a predetermined higher-temperature-side second temperature; and
a composite valve device connected to the first supply portion and the second supply portion, the composite valve device being configured to allow the lower temperature fluid supplied from the first supply portion and the higher temperature fluid supplied from the second supply portion to flow through the flow passage for temperature control after adjusting the mixture ratio and to branch and return a mixed fluid of the lower temperature fluid and the higher temperature fluid, which has flowed through the flow passage for temperature control, to the first supply means and the second supply means,
wherein the composite valve device of claim 1 is used as the composite valve device.
